(19) United States
(12) Patent Application Publication
(10) Pub. No.: US 2008/0296398 A1
(43) Pub. Date: Dec. 4, 2008

(54) Systems and methods for spraying water and mixtures of water and other materials

(76) Inventors: Ralph Hickman, Brecksville, OH (US); Stephen P. Casteel, Canal Fulton, OH (US); Michael Jackson, Wooster, OH (US)

Correspondence Address: SCHACHT LAW OFFICE, INC., SUITE 202, 2801 MERIDIAN STREET, BELLINGHAM, WA, 98225-2412, US

(21) Appl. No.: 12/008,508

(22) Filed: Jan. 11, 2008

Related U.S. Application Data
(60) Provisional application No. 60/880,229, filed on Jan. 11, 2007.
(60) Provisional application No. 60/930,854, filed on May 18, 2007.

(51) Int. Cl. B05B 7/04; A01C 23/04; B05B 7/26

(52) U.S. Cl. 239/8; 239/310; 239/337; 239/600

(57) ABSTRACT

A mixing spray device adapted to mix an added material with source water supplied from a hose. The mixing spray device comprises a main body and a container that may be detachably attached to the main body. The mixing spray device may be configured to operate in an off configuration in which nothing is dispensed, a water configuration in which only water is dispense, and a mixture configuration in which both water and the added material are dispensed. The mixing spray device may also comprise an attachment assembly that is rotatably connected to a handle portion. The container is detachably attached to the attachment assembly and thus may rotate relative to the handle portion. The container may be provided with a container member, an interface member, and a restriction member. The container may be attached to the main body using a flange on the container and a latch structure on the main body.

### RELATED APPLICATIONS

This application claims priority of U.S. Provisional Patent Application Nos. 60/880,229 filed Jan. 11, 2007, and 60/930,854 filed May 18, 2007. The contents of all related applications listed above are incorporated herein by reference.

### TECHNICAL FIELD

The present invention relates to spray nozzles adapted to be attached to a water hose and, more particularly, to spray nozzles that selectively allow only water to be sprayed or a mixture of water and another material to be sprayed.

### BACKGROUND OF THE INVENTION

Water under pressure is often applied to a desired area such as a lawn, garden, vehicle, structure, or the like. Desirably, the manner in which the water is applied is controlled. For example, the user should be able to control both the volume of water applied and the spray pattern formed by the applied water. Numerous hose end sprayers have been developed that allow the user to control both the volume and the spray pattern of the applied water.

In addition, other materials are often mixed with the applied water. In the context of a lawn or garden, fertilizers and/or pesticides may be mixed with the applied water. In the context of a vehicle or structure, detergents may be mixed with the applied water to facilitate cleaning of the vehicle of structure. Numerous mixing spray devices have been developed that allow an added material to be mixed with the applied water so that the mixture of the added material and the applied water is deposited in the desired area. The added material and water are mixed such that the spray of the mixture substantially uniformly distributes the added material throughout the desired area.

Mixing spray devices are similar to hose end sprayers but typically further comprise a hopper to contain the added material. Additionally, mixing spray devices can be configured to comprise a more complex valve structure that allows the mixing spray device to be placed in one of three configurations: an off configuration (neither water nor added material is dispensed); a water configuration (only water is dispensed); or a mixture configuration (the mixture of water and the added material is dispensed).

In mixing spray devices, the hopper structure may be arranged above or below a mixing chamber. In either case, the mixing spray device defines a predetermined up and down configuration that limits the storage and use of the device. The need exists for mixing spray devices that are more flexible in storage and use.

In addition, while mixing spray devices typically comprise an outlet structure that allows the spray pattern to be altered, this outlet structure precludes the use of any attachment at the point at which water is dispensed. The need thus further exists for mixing spray devices that can be used with a variety of attachments that may be selected based on the particular environment in which the device is to be used.

### SUMMARY OF THE INVENTION

The present invention may be embodied as a mixing spray device adapted to mix an added material with source water supplied from a hose. The mixing spray device comprises a main body and a container that may be detachably attached to the main body. The mixing spray device may be configured to operate in an off configuration in which nothing is dispensed, a water configuration in which only water is dispense, and a mixture configuration in which both water and the added material are dispensed. The mixing spray device may also comprise an attachment assembly that is rotatably connected to a handle portion. The container is detachably attached to the attachment assembly and thus may rotate relative to the handle portion. The container may be provided with a container member, an interface member, and a restriction member. The container may be attached to the main body using a flange on the container and a latch structure on the main body.

### BRIEF DESCRIPTION OF THE DRAWINGS

FIG. 1 is a perspective view of a first example mixing spray device of the present invention in a first configuration;

FIG. 2 is a perspective view of the first example mixing spray device in a second configuration;

FIG. 3 is a highly schematic cutaway view depicting the first example mixing spray device in the first configuration;

FIG. 4 is a schematic cutaway view similar to FIG. 3 depicting the first example mixing spray device in the second configuration;

FIG. 5 is a partial schematic cutaway view depicting a first optional accessory attached to the first example mixing spray device;

FIG. 6 is a partial schematic cutaway view depicting a second optional accessory attached to the first example mixing spray device;

FIG. 7 is a partial schematic cutaway view depicting a third optional accessory attached to the first example mixing spray device, with the third optional accessory in a retracted configuration;

FIG. 8 is a partial schematic cutaway view depicting the third optional accessory attached to the first example mixing spray device in an extended configuration;

FIG. 9 is a partial schematic cutaway view depicting a first optional accessory attached to a second example mixing spray device;

FIG. 10 is a partial schematic cutaway view depicting a second optional accessory attached to the second example mixing spray device;

FIG. 11 is a partial schematic cutaway view depicting a third optional accessory attached to the second example mixing spray device, with the third optional accessory in a retracted configuration;

FIG. 12 is a partial schematic cutaway view depicting the third optional accessory, in an extended configuration, attached to the second example mixing spray device;

FIG. 13 is a side elevation view of a second example mixing spray device of the present invention in a first configuration;

FIG. 14 is a side elevation view of the second example mixing spray device in a second configuration;

FIG. 15 is a front elevation view of an outlet member of the second example mixing spray device;

FIG. 16 is a section view of the second example mixing spray device in the first configuration;

FIG. 17 is a section view of the second example mixing spray device in the second configuration;

FIG. 18 is a section view illustrating the second example mixing spray device in a third configuration in which a container assembly is detached;

FIG. 19 is a section view of the second example mixing spray device in the second configuration illustrating operation of a trigger assembly;

FIG. 20 is a section view of the second example mixing spray device in the second configuration illustrating operation of a trigger lock assembly;

FIG. 21 is a section view of the second example mixing spray device in the second configuration illustrating operation of a mixing assembly;

FIG. 22 represents details of a first portion of the second example mixing spray device as depicted in FIG. 16;

FIG. 23 represents details of a second portion of the second example mixing spray device as depicted in FIG. 16;

FIGS. 24 and 25 represent details of a portion of the second example mixing spray device as depicted in FIG. 16 illustrating a latch assembly thereof;

FIG. 26 is a section view of a portion of the second example mixing spray device illustrating a second optional outlet assembly;

FIG. 27 is a section view of a portion of the second example mixing spray device illustrating a third optional outlet assembly;

FIG. 28 is a section view of a portion of the second example mixing spray device illustrating a fourth optional outlet assembly in a first configuration;

FIG. 29 is a section view of a portion of the second example mixing spray device illustrating the fourth optional outlet assembly in a second configuration;

FIG. 30 is a side elevation view of a third example mixing spray device of the present invention in a first configuration;

FIG. 31 is a section view of the third example mixing spray device in the first configuration;

FIG. 31A is an enlarged view of a portion of FIG. 31 depicting a host connect portion of the third example mixing spray device;

FIG. 32 is a section view of the third example mixing spray device in the second configuration;

FIG. 33 is a section view of the third example mixing spray device in the second configuration illustrating operation of a trigger assembly;

FIG. 34 is a section view of the third example mixing spray device in the second configuration illustrating operation of a trigger lock assembly;

FIG. 35 represents details of a second portion of the third example mixing spray device as depicted in FIG. 31;

FIGS. 35A and 35B are plan and section views, respectively, of a restriction member depicted in FIG. 35;

FIGS. 36 and 37 represent details of a portion of the third example mixing spray device as depicted in FIG. 31 illustrating a latch assembly thereof; and

FIGS. 38-40 represent details of a portion of the third example mixing spray device generally taken along lines 38-38 in FIGS. 35 and 36 and 39-39 in FIG. 37.

### DETAILED DESCRIPTION OF THE INVENTION

### I. First Example

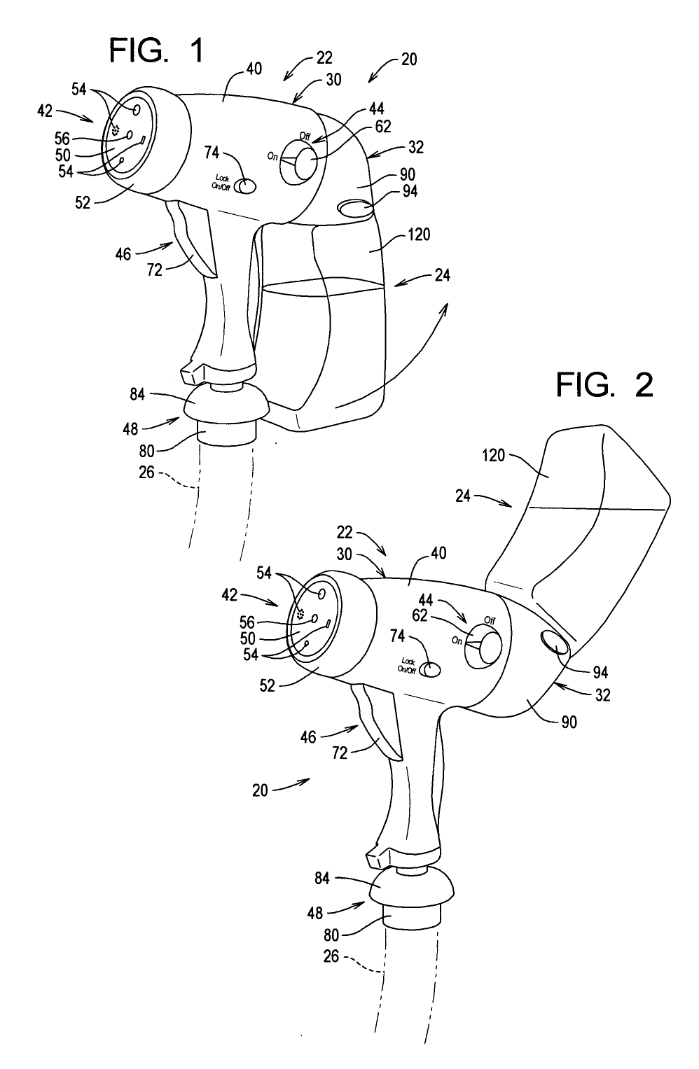

Referring initially to FIGS. 1 and 2 of the drawing, depicted at 20 therein is a first example mixing spray device constructed in accordance with, and embodying, the principles of the present invention. The example mixing spray device 20 comprises a handle portion 22 and a bottle portion 24. The handle portion 22 of the mixing spray device 20 is adapted to be connected to a hose 26 and is also adapted to support the bottle portion 24. The hose 26 delivers a supply of pressurized water to the device 20 and is not per se part of the present invention.

In general, the mixing spray device 20 operates in a first mode in which nothing is dispensed therefrom, a second mode in which only pressurized water is dispensed therefrom, and in a third mode in which a mixture of pressurized water and an additive material is dispensed therefrom. The term “sprayed material” will be used herein to refer either to the water dispensed in the second mode or to the mixture of water and additive material dispensed in the third mode.

The example mixing spray device 20 is configured such that the bottle portion 24 may be arranged in different configurations relative to the handle portion 22. In particular, the bottle portion 24 may be arranged in first (FIG. 1) and second (FIG. 2) configurations relative to the handle portion 22. The ability to arrange the bottle portion 24 in different configurations relative to the handle portion 22 renders the mixing spray device 20 significantly more flexible in storage and use than conventional mixing spray devices.

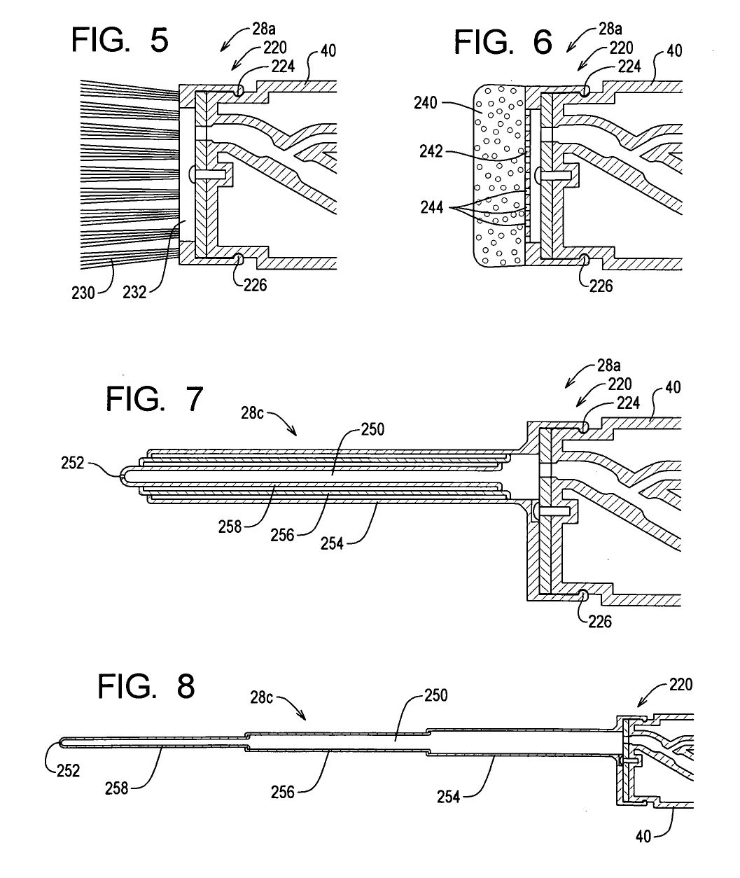

In addition, FIGS. 5-8 illustrate that the example mixing spray device 20 can be used with a plurality of accessories such as first, second, and third accessories 28a, 28b, and 28c. The accessories 28 are detachably attached to the handle portion 22.

Given the foregoing general understanding of construction and operation of the mixing spray device, the details of construction and operation of the example mixing spray device 20 will now be described.

The handle portion 22 of the example device 20 comprises a handle assembly 30 and a bottle attachment assembly 32. The example handle assembly 30 comprises a fixed housing assembly 40, an outlet assembly 42, a selector assembly 44, a trigger assembly 46, and a hose connect assembly 48. The fixed housing assembly 40 can take many different forms but desirably facilitates gripping of the mixing spray device 20 and aiming of the sprayed material.

The example outlet assembly 42 comprises a spray plate 50 and a collar member 52. The spray plate 50 defines one or more outlet openings 54. When a plurality (two or more) of the outlet openings 54 is provided, the spray plate 50 can be made movable relative to the fixed housing assembly 40 such that sprayed material can be directed through a selected one of the outlet openings 54. The example spray plate 50 is attached to the fixed housing assembly 40 by an optional screw 56.

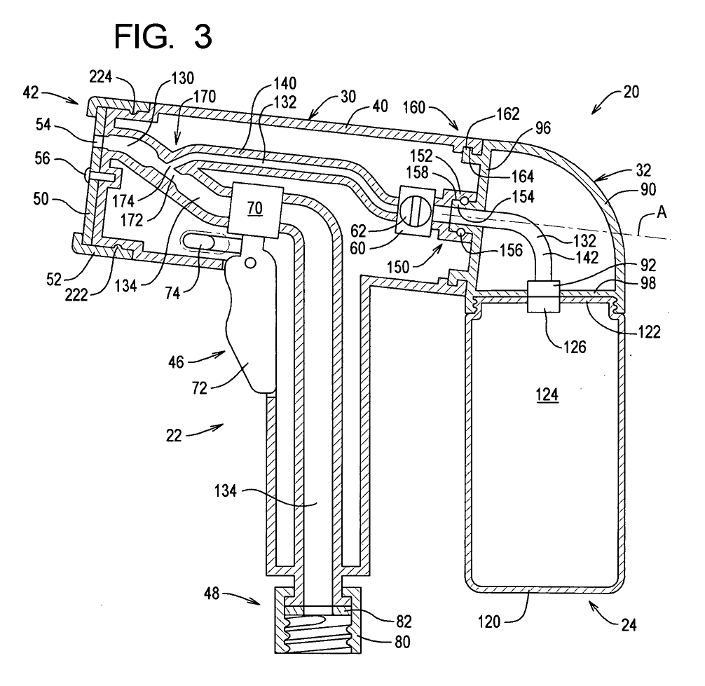

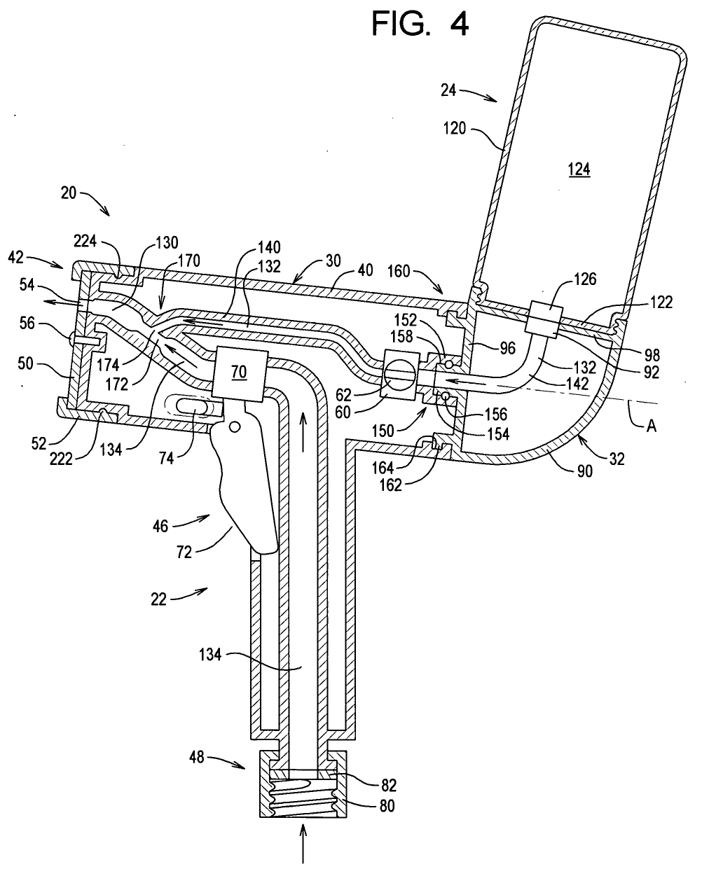

The example selector assembly 44 comprises a selector valve assembly 60 (FIGS. 3 and 4) and a selector knob 62. As will be described in further detail below, the selector knob 62 is movable between on or off positions to place the selector valve assembly 60 in closed (FIG. 3) or open (FIG. 4) configurations, respectively. In the open configuration, the selector valve assembly 60 allows fluid to flow from the bottle portion 24 to the selected outlet opening 54. In the closed configuration, the selector valve assembly 60 prevents fluid from flowing from the bottle portion 24 to the selected outlet opening 54.

The example trigger assembly 46 comprises a trigger valve assembly 70 (FIGS. 3 and 4), a trigger member 72 (FIGS. 1 and 2), and an optional lock member 74 (FIGS. 1 and 2). The valve assembly 70 is also operable in open or closed configurations. In the open configuration, the trigger valve assembly 70 allows fluid to flow from the hose 26 to the selected outlet opening 54. In the closed configuration, the trigger valve assembly 70 prevents fluid from flowing from the hose 26 to the selected outlet opening 54.

The example trigger member 72 is supported by the fixed housing assembly 40 for movement between a first position (FIG. 3) and a second position (FIG. 4, but is biased towards the first position. When the trigger member 72 is in the first position, the trigger valve assembly 70 is in the closed configuration. When the trigger member 72 is in the second position, the trigger valve assembly 70 is in the open position.

The optional lock member 74 may be moved between locked (FIG. 3) and unlocked (FIG. 4) positions. When the lock member 74 is in the locked position, the lock member 74 holds the trigger member 72 in the second position. When the lock member 74 is in the unlocked position, the trigger member 72 may be moved between the first and second positions.

When the trigger member 72 is in the first position, the mixing spray device 20 is in the first mode. The state of the selector knob 62 does not matter when the mixing spray device 20 is in the first mode. However, when the trigger member 72 is in the second position, the mixing spray device 20 is in the second mode if the selector knob 62 is in the off position and in the third mode if the selector knob 62 is in the on position.

The example hose connect assembly 48 comprises a hose connector 80, a gasket 82 (FIGS. 3 and 4), and an optional deflecting member 84 (not shown in FIGS. 3 and 4). The hose connector 80 is or may be conventional and is rotatable relative to the fixed housing assembly 40 to allow the hose 26 to be connected to the mixing spray device 20 without rotating the fixed housing assembly 40. The gasket 82 forms a seal at the juncture of the hose 26 and the hose connector 80. The deflecting member 84 deflects any pressurized water that may leak at the juncture of the hose 26 and the hose connector 80 back along the hose 26.

The bottle attachment assembly 32 comprises a movable housing assembly 90, a bottle host valve assembly 92, and one or more optional latch buttons 94. The movable housing assembly 90 defines first and second walls 96 and 98. The first wall 96 is adjacent to the fixed housing assembly 40; a rotation axis A extends through the first wall 96. The second wall 98 supports the host valve assembly 92.

The bottle portion 24 comprises a bottle member 120 defining an end wall 122 and a bottle chamber 124. The end wall 122 supports a bottle valve assembly 126. The bottle valve assembly 126 is normally closed. When the bottle portion 24 is attached to the handle portion 22, the bottle valve assembly 126 engages the host valve assembly 92 such that the bottle valve assembly 126 is placed in an open configuration to allow fluid flow between the bottle chamber 124 and the handle portion 22 as will be described in further detail below. When the host valve assembly 92 is engaged with the bottle valve assembly 126, the combination of these valve assemblies 92 and 126 allows air to flow into the bottle chamber 124 to replace liquid flowing out of the bottle chamber 124.

Referring now to FIGS. 3 and 4, it can be seen that the handle portion 22 further defines mixing chamber 130. A bottle passageway 132 extends between the host valve assembly 92 and the mixing chamber 130. A water passageway 134 extends between the hose connector 80 and the mixing chamber 130. The selector valve assembly 60 is arranged in the bottle passageway 132, and the trigger valve assembly 70 is arranged in the water passageway 134.

The bottle passageway 132 is formed by first and second conduit structures 140 and 142. The first and second conduit structures 140 and 142 are coupled using a fluid coupling assembly 150. The example fluid coupling assembly 150 is formed by a first coupler member 152, a second coupler member 154, and a sealing ring 156. The second coupler member 154 snugly fits within the first coupler member 152, with a gap 158 defined therebetween. The sealing ring 156 is arranged to fill the gap 158 substantially to prevent fluid flow through the gap 158. The fluid coupling assembly 150 allows the second conduit structure 142 to rotate relative to the first conduit structure 140 about the axis A yet provides a substantially fluid tight seal.

A mechanical coupling assembly 160 couples the movable housing assembly 90 to the fixed housing assembly 40. The example mechanical coupling assembly 160 comprises a coupling ring 162 and an annular coupling groove 164. The coupling ring 162 engages the coupling groove such that the movable housing assembly 90 can rotate about the axis A relative to the fixed housing assembly 40 but cannot move in either direction along the axis A relative to the fixed housing assembly 40.

As shown by FIGS. 3 and 4, a venturi structure 170 is formed immediately prior to the mixing chamber 130. The venturi structure 170 is formed by a restriction 172 and an opening 174. The opening 174 is formed within the restriction 172 and allows fluid communication between the bottle passageway 132 and the water passageway 134.

Turning now to FIGS. 5-8 of the drawing, depicted therein is an attachment assembly 220 that allows the collar 52 or any one of the attachments 28 to be detachably attached to the example mixing spray device 20. The collar and/or attachments may be detachably attached to the mixing spray device 20 using any one of a number of attachment systems.

The example attachment system 220 comprises one or more detent projections 222 and an annular groove 224. The detent projection 222 inwardly extends from the collar 52, and the groove 224 faces outwardly from the fixed housing assembly 40. When the collar 52 is attached to the fixed housing assembly 40, the detent projection 222 extends into the annular groove 224 to inhibit movement of the collar 52 relative to the fixed housing assembly 40. However, deliberate application of manual force on the collar 52 can cause the detent projection 222 to disengage from the groove 224, thereby allowing the collar 52 to be removed from the fixed housing assembly 40.

To detachably attach any one of the attachments 28 to the mixing spray device 20, the collar 52 is removed. An annular detent projection 226 is formed on each of the attachments 28. The detent projection 226 on the selected one of the attachments 28 engages the groove 224 to inhibit movement of the selected attachment 28 relative to the fixed housing assembly 40. As with the collar 52, however, deliberate application of manual force on the attachment 28 can cause the detent projection 226 to disengage from the groove 224, thereby allowing the attachment 28 to be removed from the fixed housing assembly 40.

The attachment 28a is a brush, the attachment 28b is a sponge, and the attachment 28c is a wand sprayer. The example brush 28a comprises bristles 230 arranged in bunches which are in turn arranged in a circular array around an opening 232. The sprayed material flows through the opening 232 onto a surface to be cleaned, and the bristles can be used facilitate cleaning of the surface.

The example sponge 28b comprises a porous sponge material 240 that is mounted on a plate 242. Holes 244 formed on the plate 242 allow the sprayed material to flow through the sponge material 240. The sponge material 240 thus is always moistened with clean liquid material to facilitate cleaning of a surface.

The example wand sprayer 28c defines a central passageway 250 through which the sprayed material is directed. The central passageway 250 extends the reach of the user and directs the sprayed material through a distal outlet opening 252 to locations that may not otherwise be accessible. The example wand sprayer 28c comprises three wand sections 254, 256, and 258 that telescopically engage each other to allow an effective length of the wand sprayer to be altered between the length shown in FIG. 7 and the length shown in FIG. 8.

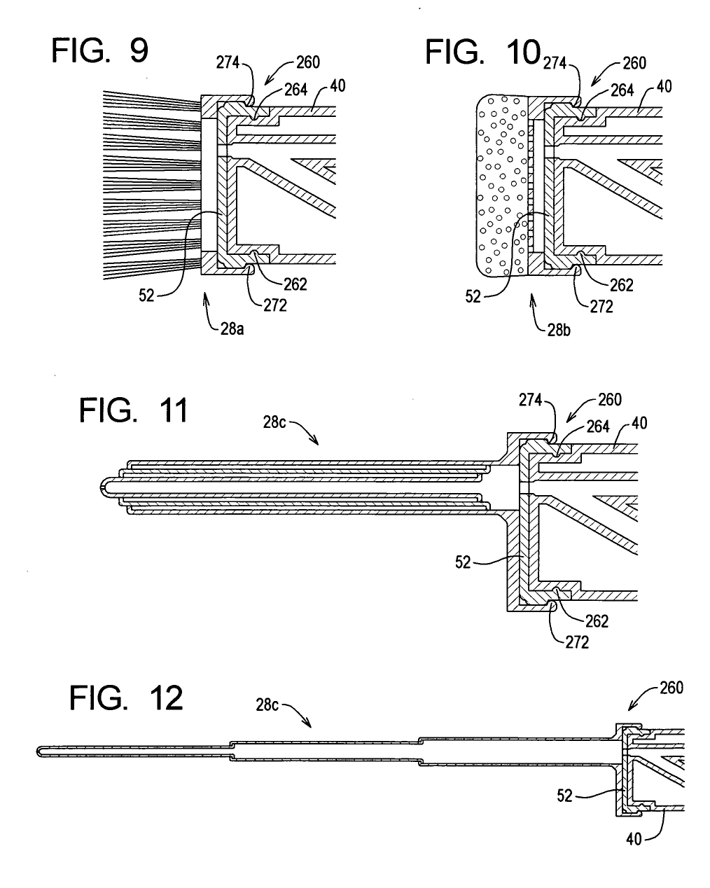

Referring now to FIGS. 9-11, depicted therein is another example attachment system 260 that may be used by the example mixing spray device 20. The example attachment system 260 comprises one or more first detent projections 262 and a first annular groove 264. The first detent projection 262 inwardly extends from the collar 52, and the groove 264 faces outwardly from the fixed housing assembly 40. When the collar 52 is attached to the fixed housing assembly 40, the detent projection 262 extends into the annular groove 264 to inhibit movement of the collar 52 relative to the fixed housing assembly 40. However, deliberate application of manual force on the collar 52 can cause the detent projection 262 to disengage from the groove 264, thereby allowing the collar 52 to be removed from the fixed housing assembly 40.

In addition, the example attachment system 260 comprises one or more second detent projections 272 and a second annular groove 274. The first detent projection 272 inwardly extends from the attachments 28, and the groove 274 faces outwardly from the collar 52. The detent projection 272 on a selected one of the attachments 28 extends into the annular groove 274 to inhibit movement of the attachment 28 relative to the collar 52 and thus the fixed housing assembly 40. However, deliberate application of manual force on the attachment 28 can cause the detent projection 272 to disengage from the groove 274, thereby allowing the attachment 28 to be removed from the collar 52 and thus the fixed housing assembly 40.

### II. Second Example

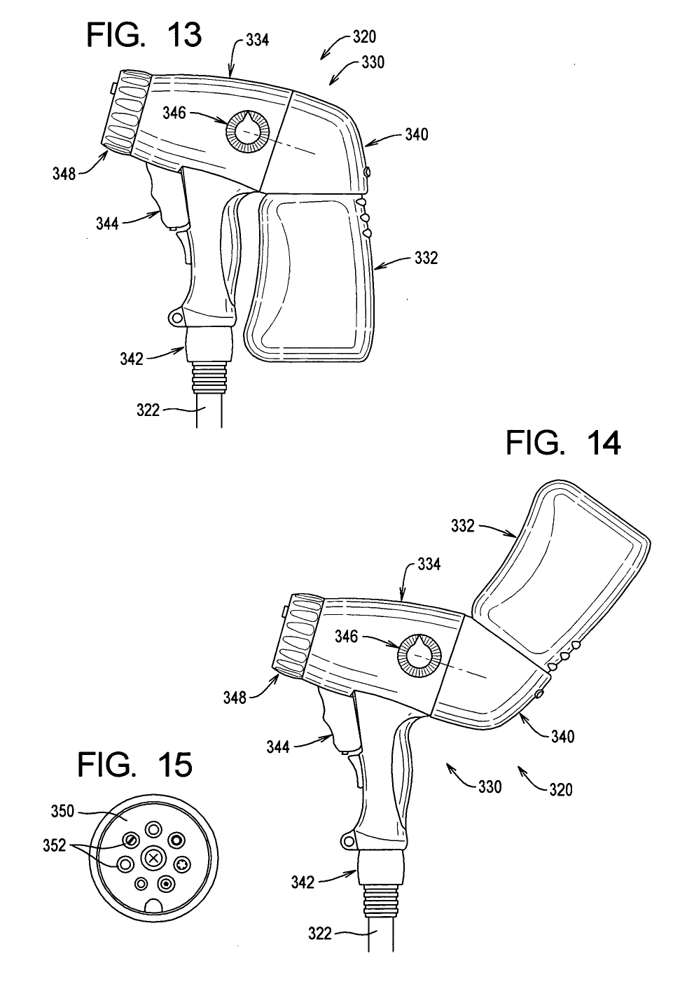

Referring now to FIGS. 13-29 of the drawing, a second example mixing spray device 320 constructed in accordance with, and embodying, the principles of the present invention. The mixing spray device 320 is adapted to be connected to a hose 322.

The mixing spray device 320 comprises a main body assembly 330 and an auxiliary container 332. The main body assembly 330 comprises a main housing assembly 334 that supports a container mounting assembly 340, a hose connect assembly 342, a trigger assembly 344, a mixing assembly 346, and an outlet assembly 348.

The example mixing spray device 320 operates basically as follows. The container mounting assembly 340 allows the auxiliary container 332 to be connected to the main body assembly 330 in either a first configuration as shown in FIG. 13 or a second configuration as shown in FIG. 14. The hose connect assembly 342 allows the hose 322 to be connected the main body assembly 330. The trigger assembly 344 controls the flow of fluid from the hose 322 to the outlet assembly 348.

Fluid may flow from the auxiliary container 332 to the outlet assembly 348 when the auxiliary container 332 is in the second configuration. Fluid is prevented from flowing from the auxiliary container 332 to the outlet assembly when the auxiliary container 332 is in the first configuration. The mixing assembly 346 controls the flow rate of the fluid flowing from the auxiliary container 332 to the outlet assembly 348.

The outlet assembly 348 determines the form in which fluid is dispensed from the mixing spray device 320. As shown in FIG. 15, the outlet assembly 348 comprises an outlet plate 350 in which is formed a number of outlet openings 352. The outlet openings 352 define different cross-sectional areas and shapes such that fluids flow through these openings 352 in different spray patterns. A screw member 354 is employed to attach the example outlet plate 350 to the main housing assembly 334, but other fastening systems such as clips, detents, threads, or the like may be used instead or in addition.

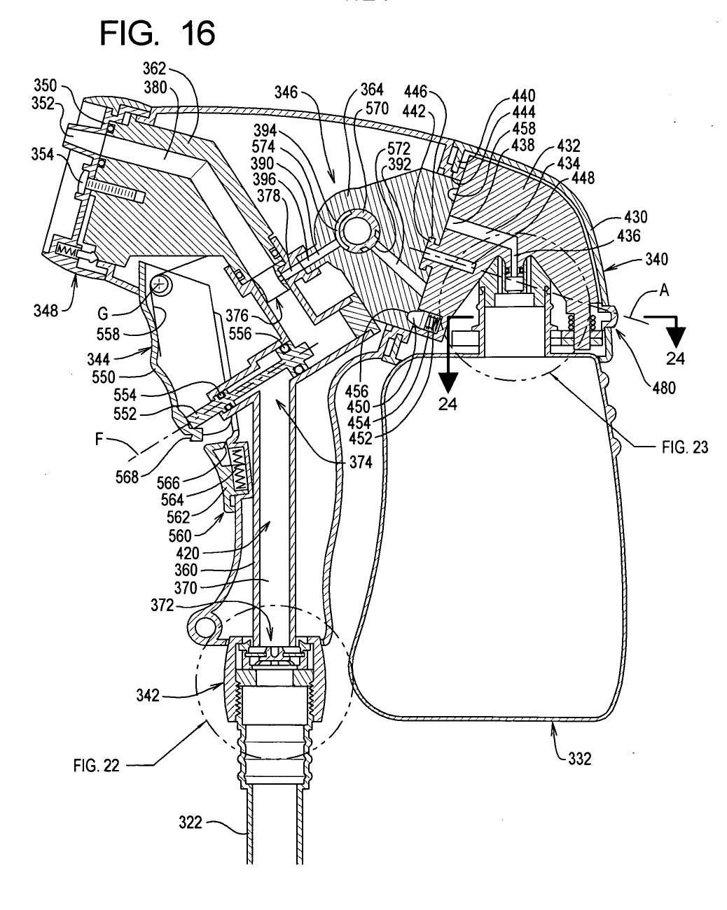

Turning now to FIGS. 16-25, the construction and operation of the example mixing spray device 320 will now be described in further detail.

The main body assembly 330 comprises, in addition to the main housing assembly 334, a first conduit member 360, a second conduit member 362, and a third conduit member 364. The first conduit member 360 defines a first passageway portion 370 comprising a main inlet portion 372, a trigger portion 374, a nozzle portion 376, and a venturi inlet portion 378. The second conduit member 362 defines a second passageway portion 380. The third conduit member 364 defines a third passageway portion 390 defining a container inlet portion 392, a mixing portion 394, and a feed portion 396.

The conduit members 360, 362, and 364 are mounted to the main housing assembly 334 such that the first and second passageway portions 370 and 380 are in fluid communication to define a main passageway 420 and the feed portion 396 of the third passageway portion 390 is in fluid communication with the venturi inlet portion 378 of the first conduit 360 to define an auxiliary passageway 422. The main passageway 420 extends between the hose 322 and a selected one of the outlet orifices 352 in the outlet plate 350. The conduit members 360, 362, and 364 are rigidly connected to the main housing assembly 334 using screws, adhesives, friction, detents, or the like.

The container mounting assembly 340 comprises an auxiliary housing assembly 430 and an auxiliary conduit member 432. The auxiliary conduit member 432 defines an auxiliary passageway 434 having an auxiliary inlet portion 436 and an auxiliary outlet portion 438. The auxiliary conduit member 432 is rigidly connected to the auxiliary housing assembly 430 using screws, adhesives, friction, detents, or the like.

The auxiliary housing assembly 430 further defines an attachment ring 440, and the auxiliary conduit member 432 defines an attachment projection 442. An annular attachment groove 444 is formed in the main housing assembly 334, and an attachment socket 446 is formed in the third conduit member 364. The attachment socket 446 defines a rotation axis A.

The attachment ring 440 engages the attachment groove 444 and the attachment projection 442 is received within the attachment socket 446 such that container mounting assembly 340 is attached to the main housing assembly 334 for rotation about the rotation axis A. A relief recess 448 is formed in the auxiliary conduit member 432 at the attachment projection 442 to facilitate entry of the attachment projection 442 into the attachment recess 446.

In addition, the container mounting assembly 340 comprises a detent member 450 and detent spring 452. The detent spring 452 is arranged to force the detent member 450 out of a detent recess 454 formed in the auxiliary conduit member 432. First and second locating recess 456 and 458 are formed in the third conduit member 364. The detent member 450 engages the first locating recess 456 to hold the auxiliary container 332 in the first configuration and engages the second locating recess 458 to hold the auxiliary container 332 in the second configuration.

While the detent member 450 engages either of the locating recesses 456 or 458 to prevent inadvertent rotation of the container mounting assembly 340, firmly forcing the container mounting assembly 340 to rotate about the rotation axis A forces the detent member 450 into the detent recess 454. With the detent member 450 within the detent recess 454, the detent member 450 disengages from the locating recesses 456 or 458, thereby allowing free rotation of the auxiliary mounting assembly 340 about the rotation axis A between the first and second configurations.

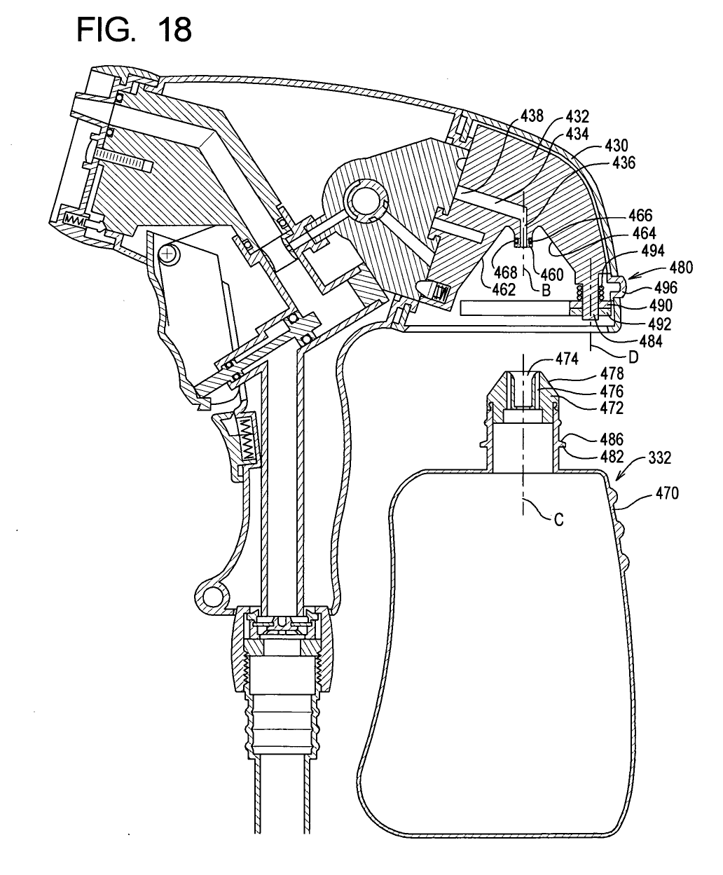

As perhaps best shown in FIG. 18, the auxiliary container 332 may be detached from the main body assembly 330 to place the mixing spray device 320 in a third configuration. In particular, the auxiliary conduit member 432 defines a nipple portion 460 and first and second guide surfaces 462 and 464. The nipple portion 460 defines an annular groove 466 that holds an O-ring 468. A mounting axis B is defined by the nipple portion 460.

The auxiliary container 332 contains a container member 470 and an interface member 472 attached thereto. The interface member 472 defines a primary opening 474 and one or more secondary openings 476. An engaging surface 478 is formed on the interface member 472. A container axis C is defined by the primary opening 474.

To attach the auxiliary container 332 to the main body assembly 330, the container axis C is aligned with the mounting axis B and the auxiliary container 332 is displaced towards the container mounting assembly 340 such that the nipple portion 460 enters the primary opening 474. The engaging surface 478 on the interface member 472 engages the guide surfaces 462 and 464 on the auxiliary conduit member 432 to facilitate entry of the nipple portion 460 into the primary opening 474. The O-ring 468 seals the gap between the nipple portion 460 and the interface member 472.

Liquids within the container member 470 can thus flow into the auxiliary passageway 434 through the primary opening 474. To replace the liquids flowing out of the auxiliary container 332, ambient air flows into the auxiliary container 332 through the at least one secondary opening 476.

The container mounting assembly 340 further comprises a latch system 480 for detachably attaching the auxiliary container 332 to the main body assembly 330. The latch system 480 can be seen in FIGS. 16-18 but is perhaps best shown in FIGS. 24 and 25.

In particular, the latch system 480 comprises a flange 382 formed on the container member 470 and a mounting post 484 extending from the auxiliary conduit member 432. A leading surface 486 on the flange 482 is angled with respect to the container axis C. The example latch system 480 further comprises first and second arm members 490 and 492, a spring member 494, and a button member 496.

The arm members 490 and 492 are pivotably supported by the mounting post 484 for rotation about a pivot axis D that is parallel to the mounting axis B. The spring member 494 biases the arm members 490 and 492 towards each other in a latched configuration (FIG. 24). Pressing the button member 496 causes the arm members 490 and 492 to rotate away from each other into an unlatched configuration (FIG. 25).

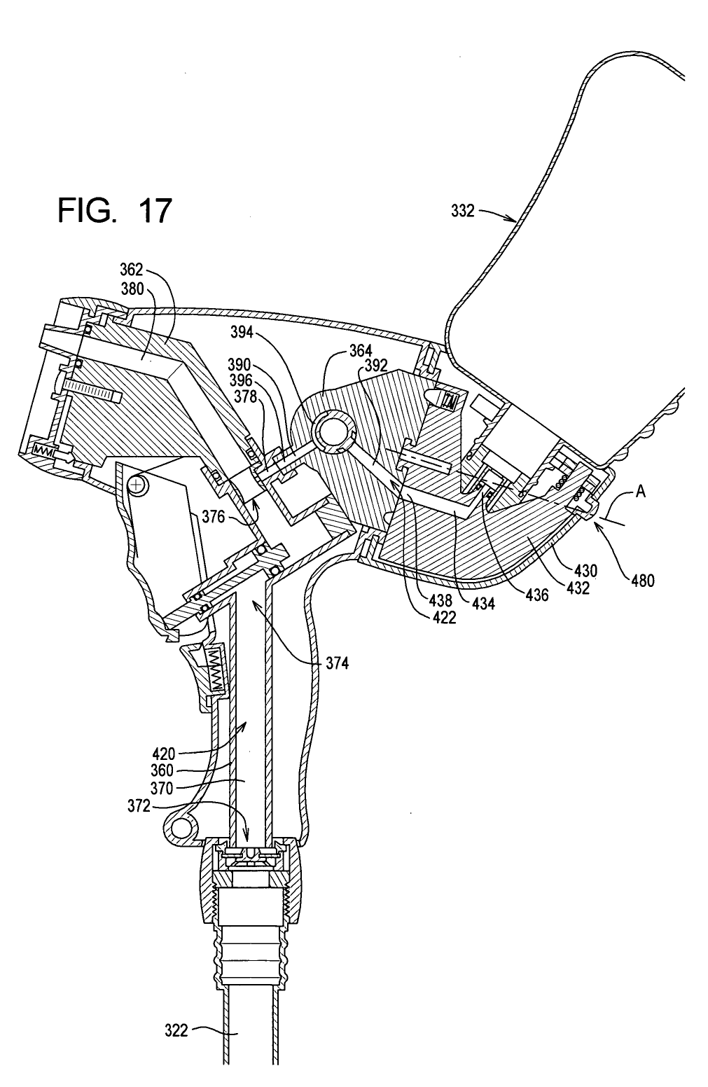

As the auxiliary container 332 is displaced relative to the main body assembly 330 such that the nipple portion 460 is received within the primary opening 474 as shown in FIGS. 16 and 17, the angled leading surface 498 on the flange 482 forces the arm members 490 and 492 out of the latched configuration, thereby allowing the flange 482 to move past the arm members 490 and 492. When the flange 482 moves past the arm members 490 and 492, the spring member 494 returns the arm members 490 and 492 into the latched configuration. At this point, the arm members 490 and 492 engage the flange 482 to prevent the auxiliary container 332 from moving away from the main body assembly 330 (FIGS. 23 and 24).

To remove the auxiliary container 332 from the main body assembly 330, the button member 496 is pushed to displace the arm members 490 and 492 into the unlatched configuration. At this point, the arm members 490 and 492 no longer engage the flange 482, and the auxiliary container 332 may be displaced away from the main body assembly 330.

The latch system 480 may take forms other than that described herein. For example, deformable detent projections extending from the container member 470 may engage openings in the auxiliary housing assembly 430 to attach the auxiliary container 332 to the main body assembly 330. Deforming such detent projections to disengage them from the openings allows the auxiliary container 332 to be detached from the main body assembly 330.

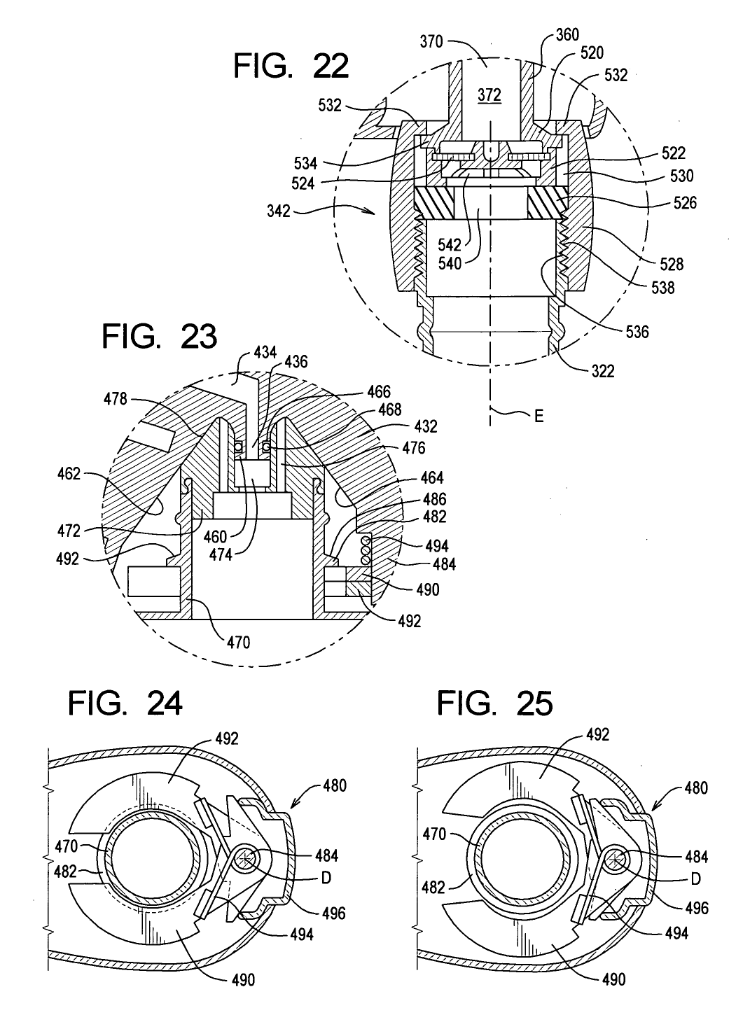

Turning now to FIGS. 16 and 22, the hose connect assembly 342 will now be described in further detail. The example hose connect assembly 342 comprises a flared end portion 520 of the first conduit member 360, a spider member 522, a screen member 524, a gasket member 526, and connector member 528. The connector member 528 defines an internal chamber 530 and comprises a ring portion 532.

The ring portion 532 of the connector member 528 engages a complementary ring portion 534 extending from the flared end portion 520. The ring portions 532 and 534 engage each other to prevent movement of the connector member 528 along a hose connect axis E away from the first conduit member 360 but to allow the connector member 528 to rotate about the hose connect axis E relative to the first conduit member 360.

The connector member 528 thus may rotate such that a threaded portion 536 on the connector member 528 can engage a complementary threaded portion 538 on the hose 322 to tighten the hose 322 against the gasket member 526. The gasket member 526 is thus forced against the spider member 522, which is in turn forced against the flared end portion 520. The spider member 522 supports the screen member 524 against the flared end portion 520.

Liquid flowing through the hose 322 thus flows through an opening 540 in the gasket 526, and opening 542 in the spider member 522, the screen member 524, and into the main inlet portion 372 of the first passageway portion 370.

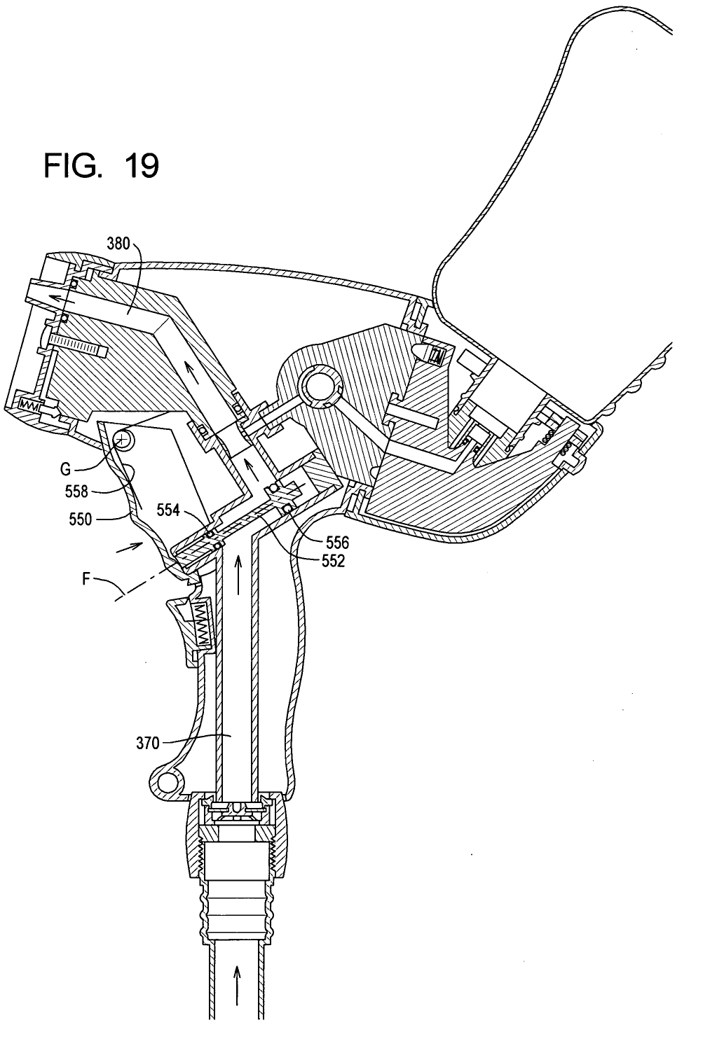

Turning now to FIGS. 16 and 19 of the drawing, the operation of the trigger assembly 344 will now be described in further detail. The trigger assembly 344 comprises a trigger member 550 and a plunger member 552. First and second plunger O-rings 554 and 556 are mounted onto the plunger member 552.

The plunger member 522 is arranged partly within the trigger portion 374 of the first passageway portion 370 and partly outside of the first passageway portion 370. The first plunger O-ring 554 prevents flow of fluid out of the first passageway portion 370 around the plunger member 522.

The plunger member 522 is arranged for movement along a plunger axis F relative to the first conduit member 360. The second plunger O-ring 556 is arranged such that the plunger member 522 prevents flow of fluid along the first passageway portion 370 when the plunger member 522 is in a closed position (FIG. 16) along the plunger axis F and allows flow of fluid along the first passageway portion 370 when the plunger member 522 is in any one of a continuum of open positions (FIG. 19) along the plunger axis F.

The trigger member 550 is pivotably connected to the main housing assembly 334 for rotation about a trigger axis G relative to the main housing assembly 334. The trigger member 550 intersects the plunger axis F such that the trigger member 550 engages the plunger member 552. A return spring 558 biases the trigger member 550 and/or the plunger member 552 such that the plunger member 522 is normally in the closed position. Forcing the trigger member 550 against the force of the return spring 558 also forces the plunger member 522 out of the closed position through the continuum of open positions.

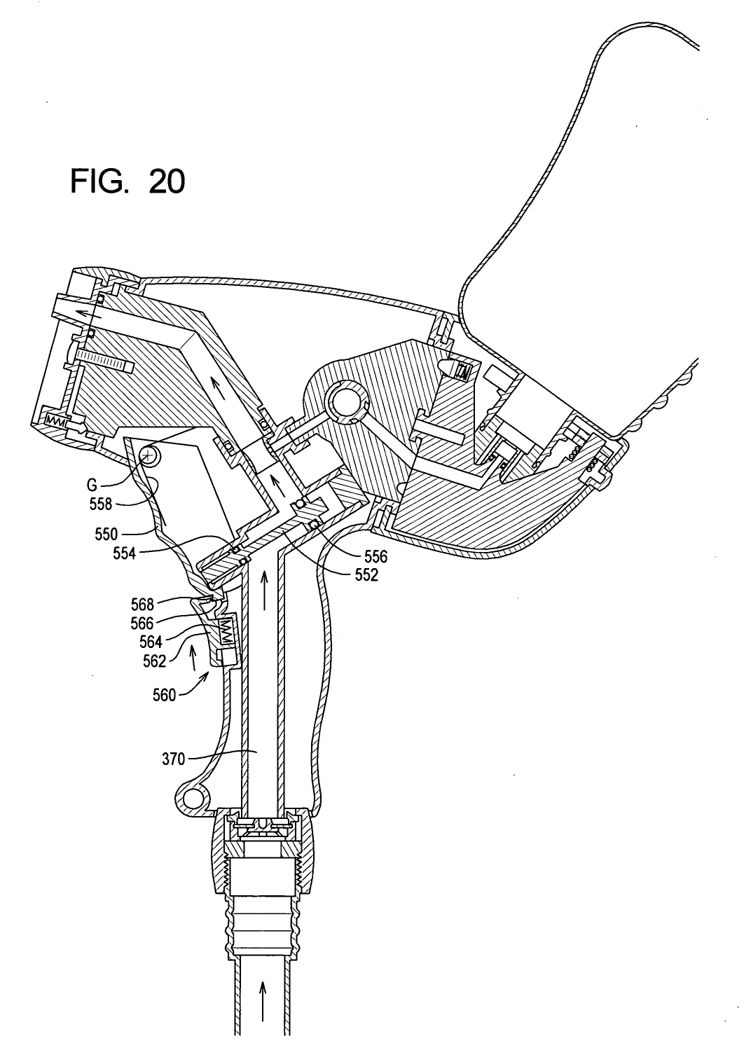

Referring now to FIGS. 16 and 20, a trigger lock assembly 560 will now be described. The trigger lock assembly 560 comprises a trigger lock member 562 that is mounted to the main housing assembly 334 for movement between an unlocked position (FIG. 16) and a locked position (FIG. 20). A trigger lock spring 564 biases the trigger lock member 562 into the unlocked position.

When the trigger lock member 562 is in the unlocked position, the trigger member 550 is free to rotate about the trigger axis G as described above. When the trigger member 550 is in a fully open position as shown in FIG. 20, the trigger lock member 562 can be displaced against the force of the trigger lock spring 564 such that a first lock surface 566 on the trigger lock member 562 engages a second trigger lock surface 568 on the trigger member 550.

The first and second trigger lock surfaces 566 and 568 are angled such that, when engaged, the trigger lock member 562 is held in the locked position; when the trigger lock member 562 is so held in the locked position, the trigger lock member 562 holds the trigger member 550 in the fully open position. However, the deliberate application of manual force to the trigger lock member 562 can disengage the lock surfaces 566 and 568, allowing the trigger lock member 562 to return to the unlocked position and thus the trigger member 550 to be rotated out of the fully open position.

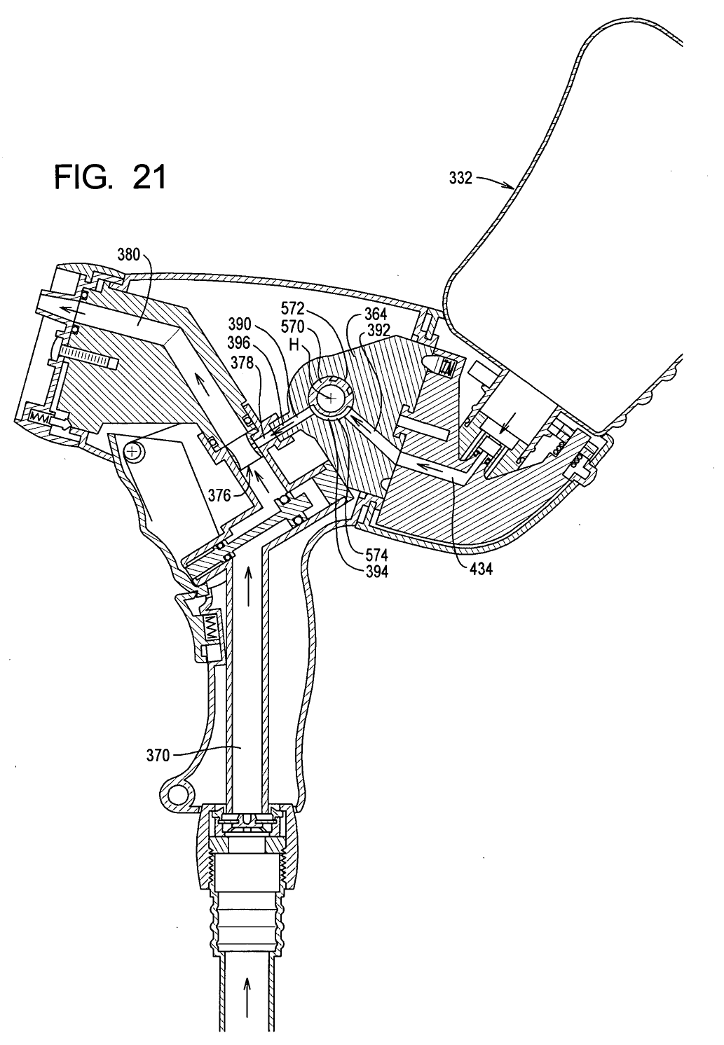

The operation of the mixing assembly 346 will now be described with reference to FIGS. 16 and 21. The mixing assembly 346 comprises a mixing cylinder 570 that is connected to a mixing dial 62 (FIG. 1). The mixing cylinder 570 is arranged within the mixing portion 394 of the third passageway portion 390. In particular, the mixing portion 394 is a cylindrical cavity sized and dimensioned to snugly receive the mixing cylinder 570 for rotation about a mixing axis H. O-rings (not shown) can be used to prevent flow of fluids out of the third passageway portion 390 around the mixing cylinder 570.

Formed on the mixing cylinder 570 is a stop surface 572 and a mixing channel 574. When the mixing cylinder 570 is in an OFF angular position relative to the third conduit member 364 (FIG. 16), the stop surface 572 is sized and dimensioned to engage the container inlet portion 392 of the third passageway portion 390 to prevent flow of fluid along the third passageway portion 390. When the mixing cylinder 570 is in any one of a continuum of ON angular positions relative to the third conduit member 364 (FIG. 21), the mixing channel 574 allows fluid to flow from the container inlet portion 392, through the mixing portion 394, and through the feed portion 396.

The feed portion 396 terminates in the venturi inlet portion 376 of the first passageway portion 370. The first passageway portion 370 narrows at the venturi inlet portion 376. As is well-known, with this geometry, fluid flowing along the first passageway portion 370 will create reduced pressure within the feed portion 396 of the third passageway portion 390. This reduced pressure will draw liquids through the third passageway 390 into the first passageway 370 when the mixing cylinder 570 is in any one of the continuum of ON positions.

The mixing assembly 346 thus allows liquid in the auxiliary container 332 to be mixed with the stream of liquid flowing along the main passageway 420 from the hose 322 to the selected one of the outlet openings 352.

The mixing spray device 320 is used as follows. The auxiliary container 332 is filled with a concentrate material to be mixed with water. The auxiliary container 332 is then attached to the main body assembly 330 by the container mounting assembly 340. At this point, the outlet plate is rotated such that a selected one of the outlet openings 352 is in fluid communication with the main passageway 420.

The mixing spray device 320 is in a storage configuration when the auxiliary container 332 is in the first configuration and in a use configuration when the auxiliary container 332 is in the second configuration. When the mixing spray device 320 is in the storage configuration, the auxiliary passageway 434 is not in fluid communication with the third passageway portion 390. However, when the mixing spray device 320 is in the use configuration, the auxiliary passageway 434 is in fluid communication with the third passageway portion 390.

The hose connect assembly 342 is connected to the hose 322; as is conventional, the hose 322 is connected to hose bib (not shown) or other source of a pressurized source of water. When the hose bib is turned on, pressurized water flows through the hose 322 and into the main passageway 420.

With the mixing spray device 320 in the use configuration and the mixing assembly 346 in one of the ON positions, the pressurized water flowing along the main passageway 420 creates negative pressure within the third passageway portion 390 that draws the concentrate material from the auxiliary container 332 into the main passageway 420. The concentrate material is thus mixed with the water within the main passageway 420 to obtain a liquid mixture, and the mixture is then dispensed through the selected one of the outlet openings 352.

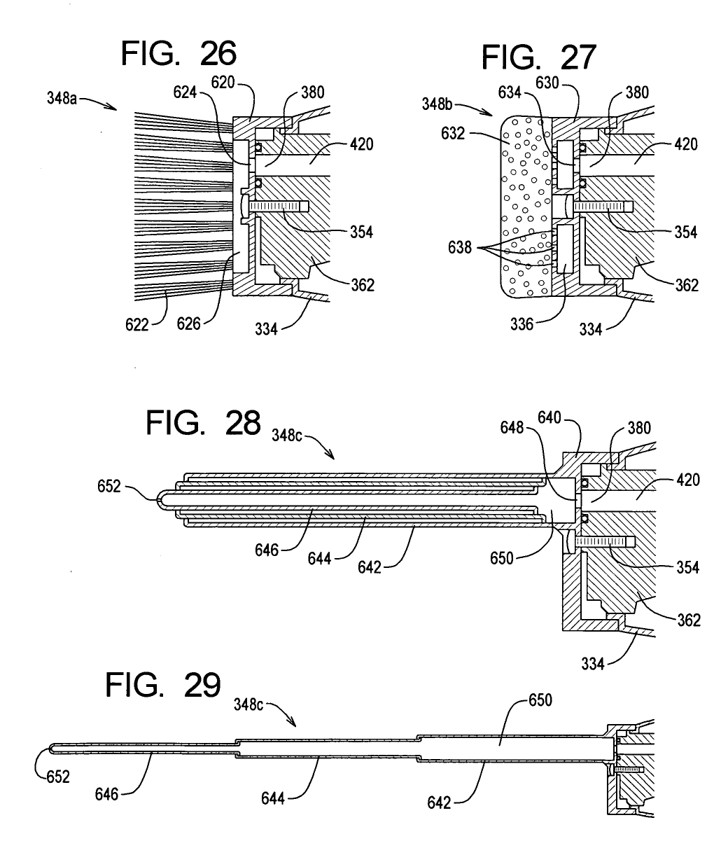

Turning now to FIGS. 26-29, first, second, and third alternative outlet assemblies 348a, 348b, and 348c will now be described. The first alternative outlet assembly 348a is a brush assembly comprising a mounting plate 620 and a plurality of bristles 622 extending from the mounting plate 620. The screw member 354 attaches the mounting plate 620 to the second conduit member 362. An opening 624 is formed in the mounting plate 620, and the opening 624 is aligned with the second passageway portion 380 of the main passageway 420. The opening 624 allows fluid to flow from the main passageway 420 into a recess 626 and through the bristles 622.

As shown in FIG. 27, the second alternative outlet assembly 348b is a sponge assembly comprising a mounting plate 630 and a sponge member 632 attached to the mounting plate 630. The screw member 354 attaches the mounting plate 630 to the second conduit member 362. An opening 634 is formed in the mounting plate 630, and the opening 634 is aligned with the second passageway portion 380 of the main passageway 420. The opening 634 allows fluid to flow from the main passageway 420 into a recess 636, through sponge openings 638, and through the sponge member 632.

The third alternative outlet assembly 348c is a wand assembly comprising a mounting plate 640 and first, second, and third wand members 642, 644, and 646. The screw member 354 attaches the mounting plate 640 to the second conduit member 362. An opening 648 is formed in the mounting plate 640, and the opening 648 is aligned with the second passageway portion 380 of the main passageway 420. The opening 648 allows fluid to flow from the main passageway 420 into a chamber 650 defined by the wand members 642, 644, and 646 and out an outlet opening 652 formed in the third wand member 646.

As shown in FIGS. 28 and 29, the first wand member 642 rigidly extends from the mounting plate 640, the second wand member 644 telescopically extends from the first wand member 642, and the third wand member 646 telescopically extends from the second wand member 644. An effective length of the third example outlet assembly 348c can be extended between a fully retracted configuration as shown in FIG. 28 and a fully extended configuration as shown in FIG. 29.

### III. Third Example

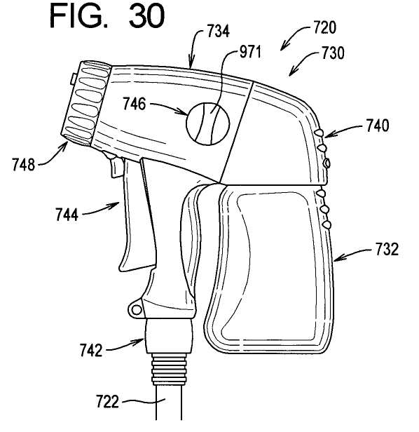

Referring now to FIGS. 30-40 of the drawing, a third example mixing spray device 720 constructed in accordance with, and embodying, the principles of the present invention. The mixing spray device 720 is adapted to be connected to a hose 722.

The mixing spray device 720 comprises a main body assembly 730 and an auxiliary container 732. The main body assembly 730 comprises a main housing assembly 734 that supports a container mounting assembly 740, a hose connect assembly 742, a trigger assembly 744, a mixing assembly 746, and an outlet assembly 748.

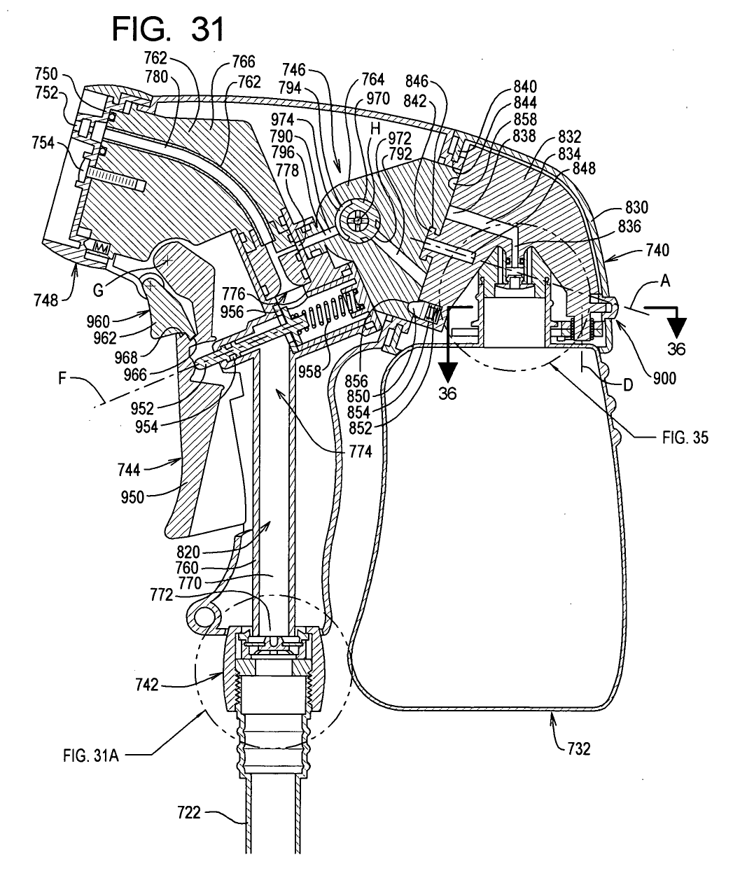

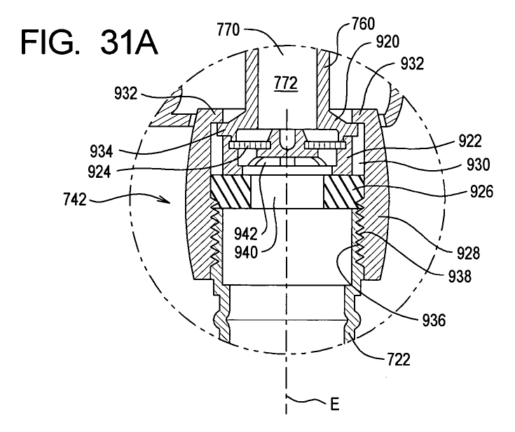

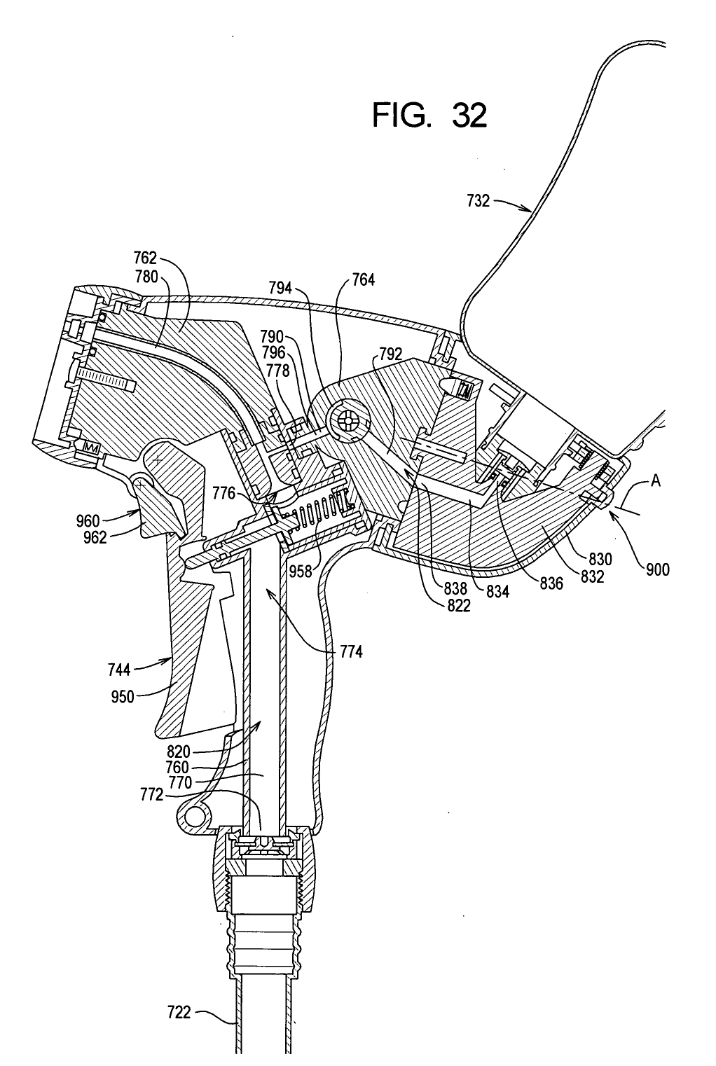

The example mixing spray device 720 operates basically as follows. The container mounting assembly 740 allows the auxiliary container 732 to be connected to the main body assembly 730 in either a first configuration as shown in FIG. 31 or a second configuration as shown in FIG. 32. The hose connect assembly 742 allows the hose 722 to be connected to the main body assembly 730. The trigger assembly 744 controls the flow of fluid from the hose 722 to the outlet assembly 748.

Fluid may flow from the auxiliary container 732 to the outlet assembly 748 when the auxiliary container 732 is in the second configuration. Fluid is prevented from flowing from the auxiliary container 732 to the outlet assembly when the auxiliary container 732 is in the first configuration.

The mixing assembly 746 comprises an outlet plate 750 in which is formed a number of outlet openings 752. A screw 754 rotatably attaches the outlet plate 750 relative to the main body assembly 730. The outlet openings 752 define different cross-sectional areas and shapes such that fluids flow through these openings 752 in different spray patterns. The mixing assembly 746 controls the flow rate of the fluid flowing from the auxiliary container 732 to the outlet assembly 748.

The outlet assembly 748 determines the form in which fluid is dispensed from the mixing spray device 720 and may be similar to the outlet assembly 348 described above.

Turning now to FIGS. 31-40, the construction and operation of the example mixing spray device 720 will now be described in further detail.

The main body assembly 730 comprises, in addition to the main housing assembly 734, a first conduit member 760, a second conduit member 762, a third conduit member 764, and a conduit support member 766. The first conduit member 760 defines a first passageway portion 770 comprising a main inlet portion 772, a trigger portion 774, a nozzle portion 776, and a venturi inlet portion 778. The second conduit member 762 defines a second passageway portion 780. The third conduit member 764 defines a third passageway portion 790 defining a container inlet portion 792, a mixing portion 794, and a feed portion 796.

The conduit members 760, 762, and 764 are mounted to the main housing assembly 734 such that the first and second passageway portions 770 and 780 are in fluid communication to define a main passageway 820 and the feed portion 796 of the third passageway portion 790 is in fluid communication with the venturi inlet portion 778 of the first conduit 760 to define an auxiliary passageway 822. The main passageway 820 extends between the hose 722 and a selected one of the outlet orifices 752 in the outlet plate 750. The conduit members 760, 762, and 764 are rigidly connected to the main housing assembly 734 using screws, adhesives, friction, detents, or the like.

The container mounting assembly 740 comprises an auxiliary housing assembly 830 and an auxiliary conduit member 832. The auxiliary conduit member 832 defines an auxiliary passageway 834 having an auxiliary inlet portion 836 and an auxiliary outlet portion 838. The auxiliary conduit member 832 is rigidly connected to the auxiliary housing assembly 830 using screws, adhesives, friction, detents, or the like.

The auxiliary housing assembly 830 further defines an attachment ring 840, and the auxiliary conduit member 832 defines an attachment projection 842. An annular attachment groove 844 is formed in the main housing assembly 734, and an attachment socket 846 is formed in the third conduit member 764. The attachment socket 846 defines a rotation axis A.

The attachment ring 840 engages the attachment groove 844 and the attachment projection 842 is received within the attachment socket 846 such that container mounting assembly 740 is attached to the main housing assembly 734 for rotation about the rotation axis A. A relief recess 848 is formed in the example auxiliary conduit member 832 at the attachment projection 842 to facilitate entry of the attachment projection 842 into the attachment recess 846.

In addition, the container mounting assembly 740 comprises a detent member 850 and detent spring 852. The detent spring 852 is arranged to force the detent member 850 out of a detent recess 854 formed in the auxiliary conduit member 832. First and second locating recess 856 and 858 are formed in the third conduit member 764. The detent member 850 engages the first locating recess 856 to hold the auxiliary container 732 in a first configuration (FIGS. 30 and 31) and engages the second locating recess 858 to hold the auxiliary container 732 in a second configuration (FIGS. 32-34).

While the detent member 850 engages either of the locating recesses 856 or 858 to prevent inadvertent rotation of the container mounting assembly 740, firmly forcing the container mounting assembly 740 to rotate about the rotation axis A forces the detent member 850 into the detent recess 854. With the detent member 850 within the detent recess 854, the detent member 850 disengages from the locating recesses 856 or 858, thereby allowing free rotation of the auxiliary mounting assembly 740 about the rotation axis A between the first and second configurations.

As perhaps best shown in FIGS. 38-40, the auxiliary container 732 may be detached from the main body assembly 730 to place the mixing spray device 720 in a third configuration. In particular, the auxiliary conduit member 832 defines a nipple portion 860 and first and second guide surfaces 862 and 864. The nipple portion 860 defines an annular groove 866 that holds an O-ring 868. A mounting axis B is defined by the nipple portion 860.

The auxiliary container 732 contains a container member 870 and an interface member 872 attached thereto. The interface member 872 defines a primary opening 874 and one or more secondary openings 876. An engaging surface 878 is formed on the interface member 872. A container axis C is defined by the primary opening 874.

To attach the auxiliary container 732 to the main body assembly 730, the container axis C is aligned with the mounting axis B and the auxiliary container 732 is displaced towards the container mounting assembly 740 such that the nipple portion 860 enters the primary opening 874. The engaging surface 878 on the interface member 872 engages the guide surfaces 862 and 864 on the auxiliary conduit member 832 to facilitate entry of the nipple portion 860 into the primary opening 874. The O-ring 868 seals the gap between the nipple portion 860 and the interface member 872.

Liquids within the container member 870 can thus flow into the auxiliary passageway 834 through the primary opening 874. To replace the liquids flowing out of the auxiliary container 732, ambient air flows into the auxiliary container 732 through the at least one secondary opening 876.

FIGS. 38-40 further illustrate that the example auxiliary container 732 further comprises a restriction member 880 attached to the interface member 872. The example restriction member 880 is a resilient body defining an engaging portion 882, an engaging ring 884, a check portion 886, and a diaphragm portion 888. The restriction member 880 further defines a restriction passageway 890 having a main portion 892 and a slit portion 894.

The engaging portion 882 of the restriction member 880 is arranged in a secured position within the primary opening 874 of the interface member 872. In this secured position, the engaging ring 884 frictionally engages the interface member 872 to fix the restriction member 880 relative to the interface member 872 such that the check portion 886 covers the secondary opening or openings 876.

With the restriction member 880 in the secured position, fluid can be drawn out of the container member 870 through the main portion 892 and out of the slit portion 894 of the restriction passageway 890 when the container member 870 is inverted. To replace fluid flowing out of the container member 870, air seeps around the check portion 886, through the secondary openings 876, and into the container member 870. The example restriction member 880 is resilient and thus allows the check portion 886 to deform under pressure to allow air to flow into the secondary openings 876.

The combination of the interface member 872 and the restriction member 880 prevents fluid from splashing out of the auxiliary container 732 but allows fluid to be drawn out of the auxiliary container 732 when used as described in further detail elsewhere.

The container mounting assembly 740 further comprises a latch system 900 for detachably attaching the auxiliary container 732 to the main body assembly 730. The latch system 900 can be seen in FIGS. 31-35 but is perhaps best shown in FIGS. 36-40.

In particular, the latch system 900 comprises a flange 902 formed on the container member 870 and a mounting post 904 extending from the auxiliary conduit member 832. A leading surface 906 on the flange 902 is angled with respect to the container axis C. A trailing surface 908 is formed on the flange opposite the leading surface 906. The trailing surface is substantially perpendicular to the container axis C. The example latch system 900 further comprises first and second arm members 910, a spring member 912, and a button member 914.

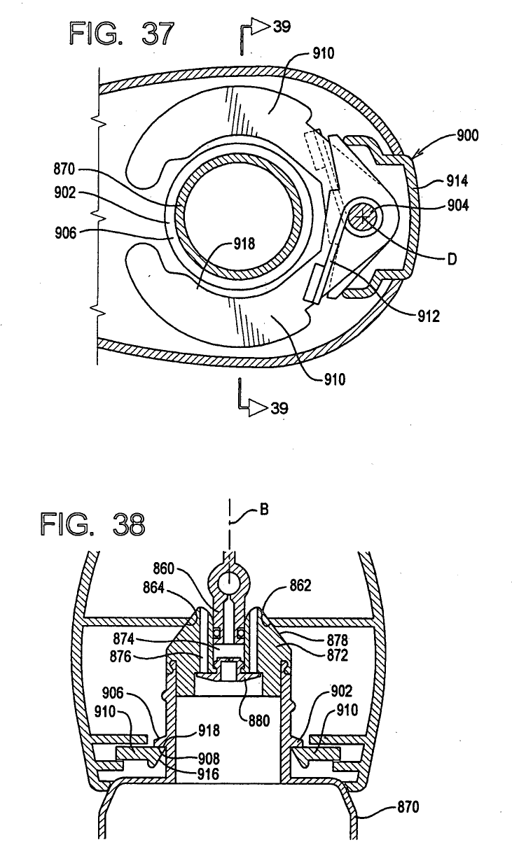

The arm members 910 are pivotably supported by the mounting post 904 for rotation about a pivot axis D that is parallel to the mounting axis B. The spring member 912 biases the arm members 910 towards each other in a latched configuration (FIGS. 36 and 38). Pressing the button member 914 causes the arm members 910 to rotate away from each other into an unlatched configuration (FIGS. 37 and 39).

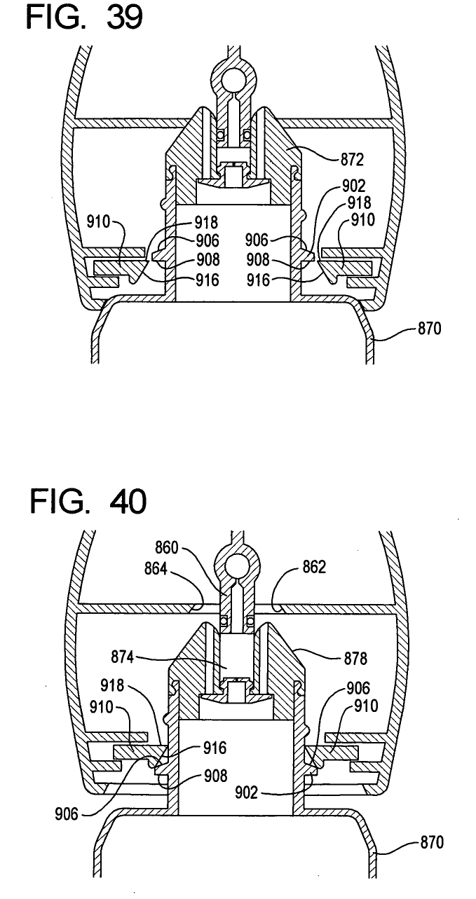

As the auxiliary container 732 is displaced relative to the main body assembly 730 in a first direction along the mounting axis B such that the nipple portion 860 is received within the primary opening 874, the angled leading surface 906 on the flange 902 engage the angled displacement surfaces 916 on the arm members 910 to force the arm members 910 out of the latched configuration (FIG. 40), thereby allowing the flange 902 to move past the arm members 910. The angling of the surfaces 906 and 916 act causes these surfaces to act as cam surfaces to facilitate displacement of the arm members 910 away from the mounting axis B.

When the flange 902 moves past the arm members 910, the spring member 912 returns the arm members 910 into the latched configuration (FIGS. 36 and 38). At this point, latch surfaces 918 on the arm members 910 engage the trailing surface 908 on the flange 902 to prevent the auxiliary container 732 from moving away from the main body assembly 730.

To remove the auxiliary container 732 from the main body assembly 730, the button member 914 is pushed to displace the arm members 910 into the unlatched configuration (FIGS. 37 and 39). At this point, the arm members 910 no longer engage the flange 902, and the auxiliary container 732 may be displaced away from the main body assembly 730 in a second direction along the mounting axis B.

The latch system 900 may take forms other than that described herein. For example, deformable detent projections extending from the container member 870 may engage openings in the auxiliary housing assembly 830 to attach the auxiliary container 732 to the main body assembly 730. Deforming such detent projections to disengage them from the openings allows the auxiliary container 732 to be detached from the main body assembly 730.

Turning now to FIG. 31A of the drawing, the hose connect assembly 742 will now be described in further detail. The example hose connect assembly 742 comprises a flared end portion 920 of the first conduit member 760, a spider member 922, a screen member 924, a gasket member 926, and connector member 928. The connector member 928 defines an internal chamber 930 and comprises a ring portion 932.

The ring portion 932 of the connector member 928 engages a complementary ring portion 934 extending from the flared end portion 920. The ring portions 932 and 934 engage each other to prevent movement of the connector member 928 along a hose connect axis E away from the first conduit member 760 but to allow the connector member 928 to rotate about the hose connect axis E relative to the first conduit member 760.

The connector member 928 thus may rotate such that a threaded portion 936 on the connector member 928 can engage a complementary threaded portion 938 on the hose 722 to tighten the hose 722 against the gasket member 926. The gasket member 926 is thus forced against the spider member 922, which is in turn forced against the flared end portion 920. The spider member 922 supports the screen member 924 against the flared end portion 920.

Liquid flowing through the hose 722 thus flows through an opening 940 in the gasket 926, an opening 942 in the spider member 922, the screen member 924, and into the main inlet portion 772 of the first passageway portion 770.

Turning now to FIGS. 31-34 of the drawing, the operation of the trigger assembly 744 will now be described in further detail. The trigger assembly 744 comprises a trigger member 950 and a plunger member 952. First and second plunger O-rings 954 and 956 are mounted onto the plunger member 952.

A return spring 958 is arranged within the trigger passageway portion 774 of the first passageway portion 770. The plunger member 952 is arranged partly within the trigger portion 774 of the first passageway portion 770 and partly outside of the first passageway portion 770. The plunger O-ring 954 prevents flow of fluid out of the first passageway portion 770 around the plunger member 952.

The plunger member 952 is arranged for movement along a plunger axis F relative to the first conduit member 760. The second plunger O-ring 956 is arranged such that the plunger member 952 prevents flow of fluid along the first passageway portion 770 when the plunger member 952 is in a closed position (FIG. 31) along the plunger axis F and allows flow of fluid along the first passageway portion 770 when the plunger member 952 is in any one of a continuum of open positions (FIG. 19) along the plunger axis F. The return spring 958 biases the plunger member 952 into the closed position.

The trigger member 950 is pivotably connected to the main housing assembly 734 for rotation about a trigger axis G relative to the main housing assembly 734. The trigger member 950 intersects the plunger axis F such that the trigger member 950 engages the plunger member 952. Forcing the trigger member 950 against the force of the return spring 958 forces the plunger member 952 out of the closed position through a continuum of open positions.

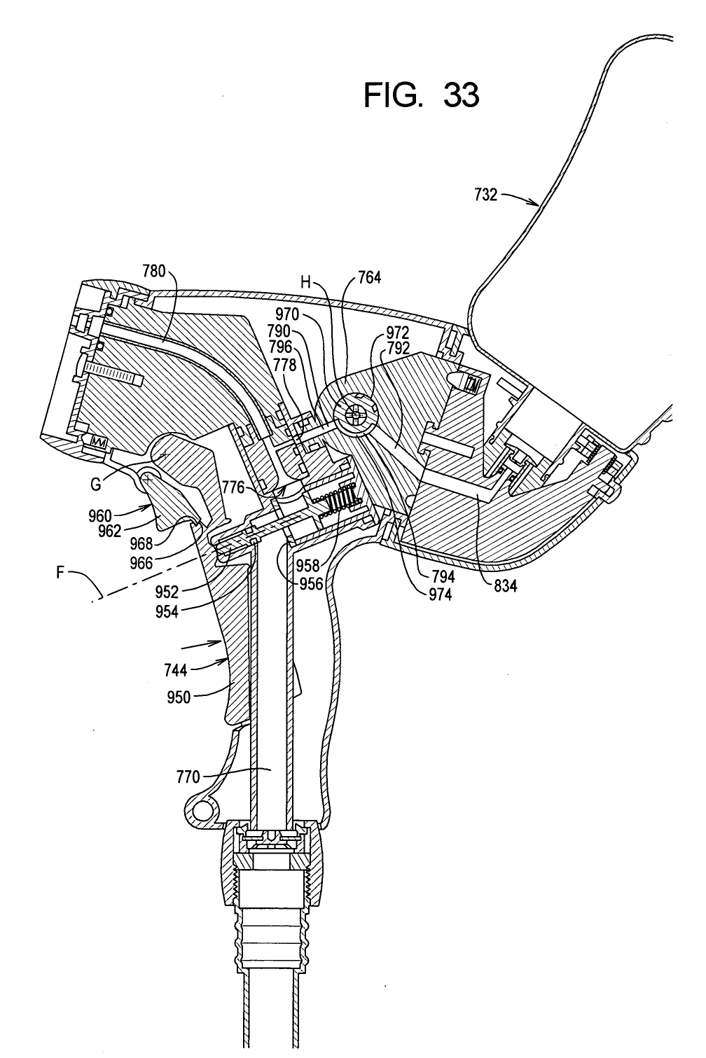

An optional trigger lock assembly 960 will now be described with reference to FIGS. 31-34. The trigger lock assembly 960 comprises a trigger lock member 962 that is mounted to the main housing assembly 734 for movement between an unlocked position (FIGS. 31 and 32) and a locked position (FIG. 33). Optionally, a trigger lock spring may be provided to bias the trigger lock member 962 into the unlocked position.

When the trigger lock member 962 is in the unlocked position, the trigger member 950 is free to rotate about the trigger axis G as described above. When the trigger member 950 is in a fully open position as shown in FIG. 33, the trigger lock member 962 can be displaced such that a first lock surface 966 on the trigger lock member 962 engages a second trigger lock surface 968 on the trigger member 950.

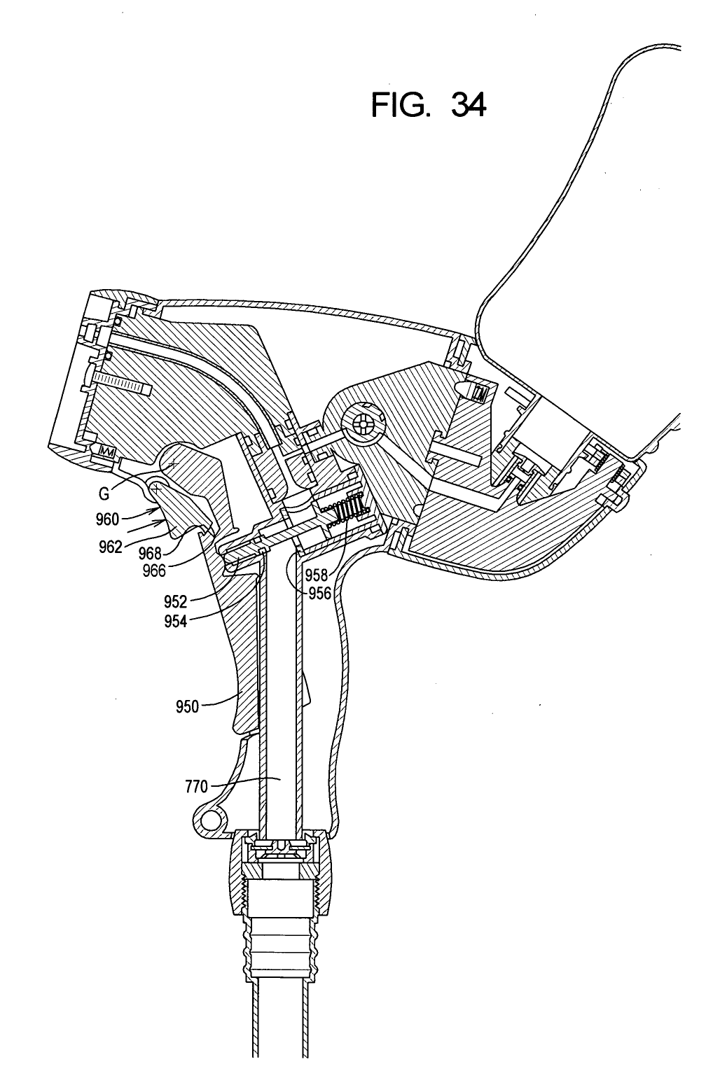

The first and second trigger lock surfaces 966 and 968 are angled such that, when engaged, the trigger lock member 962 is held in the locked position; when the trigger lock member 962 is so held in the locked position, the trigger lock member 962 holds the trigger member 950 in the fully open position. However, the deliberate application of manual force to the trigger lock member 962 can disengage the lock surfaces 966 and 968 as shown in FIG. 34, allowing the trigger lock member 962 to return to the unlocked position and thus the trigger member 950 to be rotated out of the fully open position.

The operation of the mixing assembly 746 will now be described with reference to FIG. 31. The mixing assembly 746 comprises a mixing cylinder 970 that is connected to a mixing dial 971 (FIG. 30). The mixing cylinder 970 is arranged within the mixing portion 794 of the third passageway portion 790. In particular, the mixing portion 794 is a cylindrical cavity sized and dimensioned to snugly receive the mixing cylinder 970 for rotation about a mixing axis H. O-rings (not shown) can be used to prevent flow of fluids out of the third passageway portion 790 around the mixing cylinder 970.

Formed on the mixing cylinder 970 is a stop surface 972 and a mixing channel 974. When the mixing cylinder 970 is in an OFF angular position relative to the third conduit member 764 (FIG. 31), the stop surface 972 is sized and dimensioned to engage the container inlet portion 792 of the third passageway portion 790 to prevent flow of fluid along the third passageway portion 790. When the mixing cylinder 970 is in any one of a continuum of ON angular positions relative to the third conduit member 764 (FIG. 33), the mixing channel 974 allows fluid to flow from the container inlet portion 792, through the mixing portion 794, and through the feed portion 796.

The feed portion 796 terminates in the venturi inlet portion 778 of the first passageway portion 770. The first passageway portion 770 narrows at the venturi inlet portion 778. As is well-known, with this geometry, fluid flowing along the first passageway portion 770 will create reduced pressure within the feed portion 796 of the third passageway portion 790. This reduced pressure will draw liquids through the third passageway 790 into the first passageway 770 when the mixing cylinder 970 is in any one of the continuum of ON positions.

The mixing assembly 746 thus allows liquid in the auxiliary container 732 to be mixed with the stream of liquid flowing along the main passageway 820 from the hose 722 to the selected one of the outlet openings 752.

The mixing spray device 720 is used as follows. The auxiliary container 732 is filled with a concentrate material to be mixed with water. The auxiliary container 732 is then attached to the main body assembly 730 by the container mounting assembly 740. At this point, the outlet plate is rotated such that a selected one of the outlet openings 752 is in fluid communication with the main passageway 820.

The mixing spray device 720 is in a storage configuration when the auxiliary container 732 is in the first configuration and in a use configuration when the auxiliary container 732 is in the second configuration. When the mixing spray device 720 is in the storage configuration, the auxiliary passageway 834 is not in fluid communication with the third passageway portion 790. However, when the mixing spray device 720 is in the use configuration, the auxiliary passageway 834 is in fluid communication with the third passageway portion 790.

The hose connect assembly 742 is connected to the hose 722; as is conventional, the hose 722 is connected to hose bib (not shown) or other source of a pressurized source of water. When the hose bib is turned on, pressurized water flows through the hose 722 and into the main passageway 820.

With the mixing spray device 720 in the use configuration and the mixing assembly 746 in one of the ON positions, the pressurized water flowing along the main passageway 820 creates negative pressure within the third passageway portion 790 that draws the concentrate material from the auxiliary container 732 into the main passageway 820. The concentrate material is thus mixed with the water within the main passageway 820 to obtain a liquid mixture, and the mixture is then dispensed through the selected one of the outlet openings 752.

The example mixing spray device 720 may be used with any one or more of the outlet assemblies described above with reference to FIGS. 5-8, 9-12, and/or 26-29.

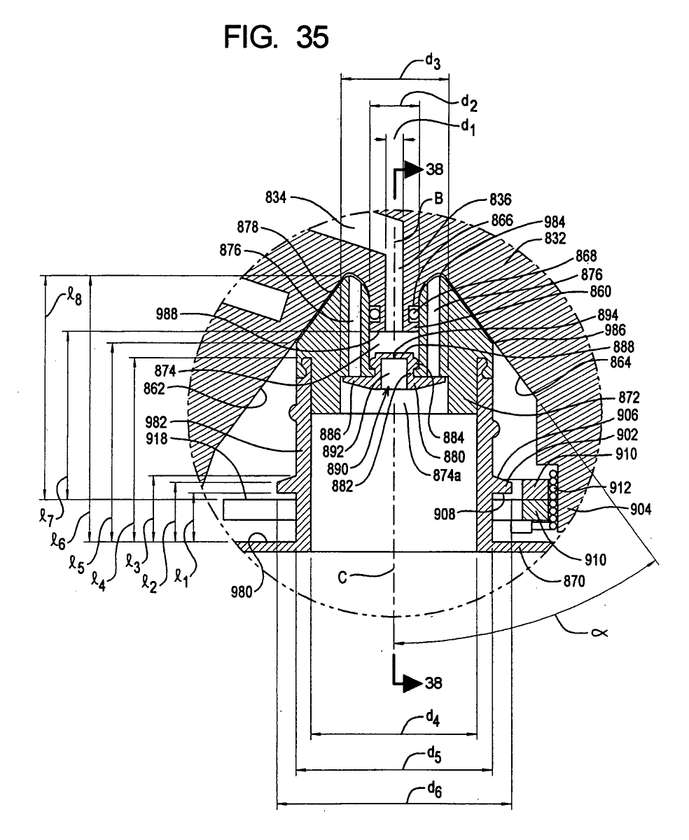

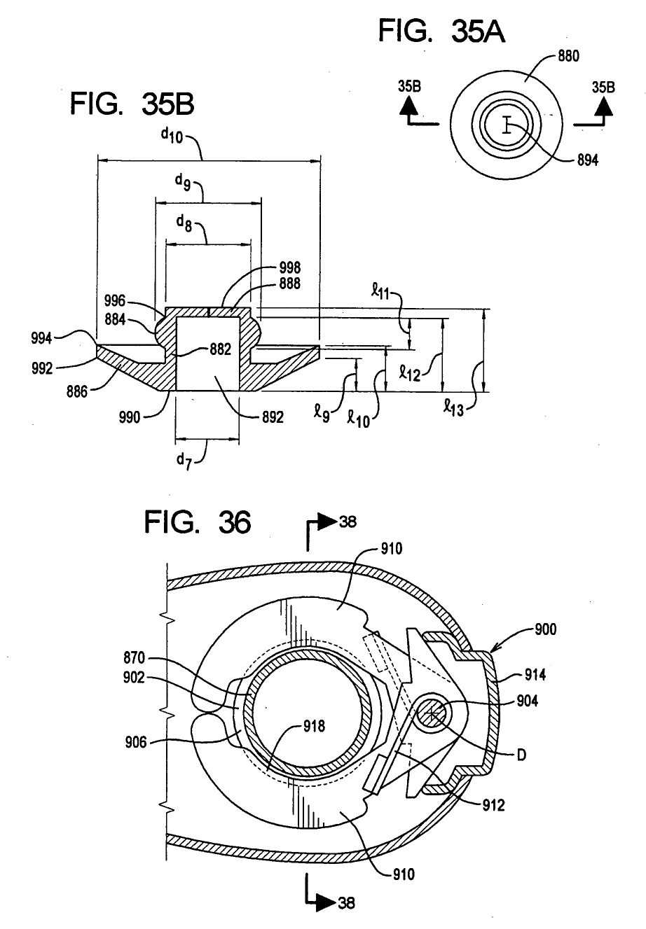

Turning now to FIGS. 35A-C of the drawing, depicted therein are dimensions of certain portions to the example auxiliary container 732 and the example container mounting assembly 740. These dimensions will be briefly described and numerically defined in the following Table A. Unless depicted or described otherwise, the numerical definitions are approximate values in millimeters and are measured along lines parallel or perpendicular to the axis C.

TABLE A

| | | | First | Second |
|---|---|---|---|---|
| | Description | Example | Range | Range |
| l₁ | distance from trailing surface | 6.5 | 6.5 ± 10% | 6.5 ± 20% |
| | 908 to container upper wall | | | |
| | 980 | | | |
| l₂ | distance from outer edge of | 8.1 | 8.1 ± 10% | 8.1 ± 20% |
| | leading surface 906 to | | | |
| | container upper wall 980 | | | |
| l₃ | distance from inner edge of | 8.7 | 8.7 ± 10% | 8.7 ± 20% |
| | leading surface 906 to | | | |
| | container upper wall 980 | | | |
| l₄ | length of connector wall 982 | 24.3 | 24.3 ± 10% | 24.3 ± 20% |
| l₅ | distance of interface member | 25.2 | 25.2 ± 10% | 25.2 ± 20% |
| | transition edge 986 from | | | |
| | container upper wall 980 | | | |
| l₆ | distance of interface member | 34.3 | 34.3 ± 10% | 34.3 ± 20% |
| | tip 984 from container upper | | | |
| | wall 980 | | | |
| α | angle at which engaging | 35° | 35° ± 10% | 35° ± 20% |
| | surface 878 extends from axis | | | |
| | C | | | |
| l₇ | distance of nipple portion end | 20.3 | 20.3 ± 10% | 20.3 ± 20% |
| | surface 988 from latch surface | | | |
| | 918 | | | |
| l₈ | distance of interface member | 27.9 | 27.9 ± 10% | 27.9 ± 20% |
| | tip 984 from latch surface 918 | | | |
| l₉ | distance from restriction | 1.8 | 1.8 ± 10% | 1.8 ± 20% |
| | member end wall 990 to check | | | |
| | portion outer edge 992 | | | |
| l₁₀ | distance from restriction | 2.5 | 2.5 ± 10% | 2.5 ± 20% |
| | member end wall 990 to check | | | |
| | portion inner edge 994 | | | |
| l₁₁ | length of engaging ring 884 | 1.8 | 1.8 ± 10% | 1.8 ± 20% |
| l₁₂ | distance from restriction | 4.1 | 4.1 ± 10% | 4.1 ± 20% |
| | member end wall 990 to | | | |
| | engaging ring inner edge 996 | | | |
| l₁₃ | distance from restriction | 4.6 | 4.6 ± 10% | 4.6 ± 20% |
| | member end wall 990 to | | | |
| | diaphragm portion inner wall | | | |
| | 998 | | | |
| d₁ | diameter of auxiliary inlet | 1.2 | 1.2 ± 10% | 1.2 ± 20% |
| | portion 836 | | | |
| d₂ | diameter of nipple portion 860 | 6.2 | 6.2 ± 10% | 6.2 ± 20% |
| d₃ | diameter of restriction seat | 12.5 | 12.5 ± 10% | 12.5 ± 20% |
| | portion 874a of primary | | | |
| | opening 874 | | | |
| d₄ | inner diameter of connector | 21.3 | 21.3 ± 10% | 21.3 ± 20% |
| | wall 982 | | | |
| d₅ | outer diameter of connector | 24.9 | 24.9 ± 10% | 24.9 ± 20% |
| | wall 982 | | | |
| d₆ | outer diameter of flange 902 | 29.4 | 29.4 ± 10% | 29.4 ± 20% |
| d₇ | diameter of restriction | 3.4 | 3.4 ± 10% | 3.4 ± 20% |
| | passageway main portion 892 | | | |
| d₈ | outer diameter of engaging | 4.6 | 4.6 ± 10% | 4.6 ± 20% |
| | portion 882 | | | |
| d₉ | outer diameter of engaging | 5.7 | 5.7 ± 10% | 5.7 ± 20% |
| | ring 884 | | | |
| d₁₀ | diameter of check portion 886 | 12.0 | 12.0 ± 10% | 12.0 ± 20% |

The present invention may be embodied in forms other than those described above and still fall within the scope of the present invention.

What is claimed is:

1. A mixing spray device adapted to mix an added material with source water supplied from a hose, comprising:
a handle portion comprising
a handle assembly comprising conduit structure defining a first inlet opening, a second inlet opening, and an outlet opening,
a hose connect assembly adapted to connect the hose to the first inlet opening;
a container attachment assembly rotatably attached to the handle assembly, and
a control structure supported by the handle assembly; and
a container adapted to contain the added material, where the container attachment assembly detachably attaches the container to the handle assembly such that
the container rotates with the attachment assembly relative to the handle assembly, and
the container is in fluid communication with the second inlet opening; wherein
the mixing spray device operates in
an off configuration in which the control structure substantially prevents fluid flow through the outlet opening,
a water configuration in which the control structure allows water to flow from the first inlet opening to the outlet opening, and
a mixture configuration in which the control structure allows a mixture of water from the first inlet opening and added material from the second inlet opening to flow to the outlet opening.

2. A mixing spray device as recited in claim 1, in which the attachment assembly rotates between first and second positions relative to the handle assembly, where the container attachment assembly comprises a detent system for securing the attachment assembly into the first and second positions.

3. A mixing spray device as recited in claim 1, further comprising at least one accessory device adapted to be detachably attached to the handle portion such that fluid flowing out of the outlet opening flows out of an accessory outlet opening formed in the at least one accessory device.

4. A mixing spray device as recited in claim 1, in which the control structure comprises a trigger assembly, where the trigger assembly operates in:
a closed position, where the mixing spray device is in the off configuration when the trigger assembly is in the closed position; and
an open position, where the mixing spray device is in one of the water configuration and the mixture configuration when the trigger assembly is in the open position.

5. A mixing spray device as recited in claim 1, in which the control structure comprises a selector assembly, where the selector assembly operates in:
a closed configuration, where the mixing spray device is in the off configuration or the water configuration when the selector assembly is in the closed position; and
an open position, where the mixing spray device is in one of the off configuration and the mixture configuration when the trigger assembly is in the open position.

6. A container assembly for a mixing spray device defining a nipple portion and a locking portion, comprising:
a container member adapted to contain additive material, where a flange portion extends from the container member;
an interface member, where the interface member defines a primary opening and at least one secondary opening;
a restriction member, where the restriction member defines
a check portion and a diaphragm portion, and
an opening portion is formed in the diaphragm portion; wherein
the restriction member is secured to the interface member such that
the opening portion is in fluid communication with the primary opening, and
the check portion covers the at least one secondary opening; and
the interface member is secured to the container member such that
fluid exits the container assembly through the opening portion and the primary opening, and
the check portion of the restriction member deforms to allow fluid to enter the container assembly through the at least one secondary opening;
the primary opening is sized and dimensioned to engage the nipple portion of the mixing spray device; and
the flange portion is sized and dimensioned to engage the locking portion of the mixing spray device.

7. A container assembly as recited in claim 6, in which the restriction member defines an engaging portion arranged within the primary opening of the interface member.

8. A container assembly as recited in claim 7, in which the restriction member defines an engaging ring that frictionally engages the interface member to fix the restriction member relative to the interface member.

9. A container assembly as recited in claim 6, in which the restriction member is made of a resilient body.

10. A container assembly as recited in claim 6, in which an engaging surface is formed on the interface member, where the engaging surface engages at least one surface on the mixing spray device to facilitate entry of the nipple portion into the primary opening.

11. An attachment system for detachably attaching an auxiliary bottle to a main body of a mixing spray device, comprising:
a flange extending from the auxiliary bottle, where the flange defines a leading surface and a trailing surface;
a latch structure supported by the main body; where
displacement of the auxiliary bottle such that the leading surface displaces the latch structure allows the auxiliary bottle to be placed in an attached configuration in which the latch structure engages the trailing surface to inhibit movement of the auxiliary bottle relative to the main body; and
displacing the latch structure disengages the latch structure from the trailing surface to allow the auxiliary bottle to be placed in a detached configuration.

12. An attachment system as recited in claim 11, in which the latch structure is supported for movement between a latched position and an unlatched position relative to the main body, the attachment system further comprising a bias member for biasing the latch structure into the latched position.

13. An attachment system as recited in claim 11, in which the leading surface is angled such that displacing the auxiliary bottle in a first direction along a mounting axis causes the leading surface to engage and displace the latch structure away from the mounting axis.

14. An attachment system as recited in claim 11, in which the latch structure defines a displacement surface and a latch surface, where:
the leading surface and the displacement surface are configured such that the leading surface engages the displacement surface to displace the latch structure to facilitate displacement of the auxiliary bottle into the attached configuration; and
the trailing surface and the latch surface are configured such that the trailing surface engages the latch surface to secure the auxiliary bottle in the attached configuration.

15. An attachment system as recited in claim 11, in which the latch structure comprises first and second arm members pivotably attached to the main body, the attachment system further comprising:
a return spring that acts on the first and second arm members to force the arm members towards each other; and
a button member arranged such that displacing the button member forces the first and second arm members away from each other.

16. A method detachably attaching an auxiliary bottle to a main body of a mixing spray device, comprising the steps of:
forming a flange on the auxiliary bottle, where the flange defines a leading surface and a trailing surface;
supporting a latch structure on the main body;
displacing the auxiliary bottle such that the leading surface engage the latch structure;
further displacing the auxiliary bottle such that the leading surface displaces the latch structure into an unlocked position to allow the auxiliary bottle to be placed in an attached configuration relative to the main body;
allowing the latch structure to return to a locked position in which the latch structure engages the trailing surface to inhibit movement of the auxiliary bottle relative to the main body;
displacing the latch structure into the unlocked position to disengage the latch structure from the trailing surface; and
displacing the auxiliary bottle into a detached configuration relative to the main body.

17. A method as recited in claim 16, further comprising the steps of:
supporting the latch structure for movement relative to the main body between a latched position and an unlatched position; and
biasing the latch structure into the latched position.

18. A method as recited in claim 16, further comprising the step of angling the leading surface such that displacing the auxiliary bottle in a first direction along a mounting axis causes the leading surface to engage and displace the latch structure away from the mounting axis.

19. A method as recited in claim 16, further comprising the steps of:
forming a displacement surface and a latch surface on the latch structure;
configuring the leading surface and the displacement surface such that the leading surface engages the displacement surface to displace the latch structure to facilitate displacement of the auxiliary bottle into the attached configuration; and
configuring the trailing surface and the latch surface such that the trailing surface engages the latch surface to secure the auxiliary bottle in the attached configuration.

20. A method as recited in claim 16, in which the step of supporting the latch structure on the main body comprises the step of pivotably attaching first and second arm members to the main body, the method further comprising the steps of:
arranging a return spring to force the first and second arm members towards each other;
arranging a button member to engage the first and second arm members; and
displacing the button member to force the first and second arm members away from each other.
